(19) United States
(12) Patent Application Publication
(10) Pub. No.: US 2026/0320615 A1
(43) Pub. Date: Oct. 15, 2026

(54) SYSTEMS AND METHODS FOR REAL-TIME FRAUD DETECTION

(71) Applicant: Synchrony Bank, Stamford, CT (US)

(72) Inventors: Tarun Saha, Fishkill, NY (US); Rajat Taneja, San Francisco, CA (US); David Chau, Brewster, NY (US)

(21) Appl. No.: 19/180,056

(22) Filed: Apr. 15, 2025

(51) Int. Cl. G06Q 20/40

(52) U.S. Cl. CPC G06Q 20/4016

(57) ABSTRACT

Systems and methods provide a framework through which transactions associated with different external systems are dynamically processed in parallel through a set of transaction analysis systems to generate insights corresponding to fraud-related patterns. During a transaction being performed through an external system, transaction data associated with the transaction is transmitted to a payment instrument authorization service for authorization. The payment instrument authorization service queries a transactional fraud platform to process the transaction data in parallel through distinct transaction analysis systems to detect any fraud-related patterns and generate insights that are usable by authorization processors to detect potentially fraudulent transactions, thereby minimizing the risk of authorizing such fraudulent transactions.

### CROSS-REFERENCE TO RELATED APPLICATIONS

The present patent application is related to U.S. Non-Provisional Patent Applications entitled “SYSTEMS AND METHODS FOR REAL-TIME FRAUD-RELATED PATTERN RECOGNITION BASED ON PRE-AUTHORIZATION RECORDS” (POL Ref. 101256-842830-016400US) filed Apr. 15, 2025 and “SYSTEMS AND METHODS FOR REAL-TIME FRAUD-RELATED PATTERN RECOGNITION BASED ON DETECTED FRAUD ACTIVITY” (POL Ref. 101256-842829-016500US) filed Apr. 15, 2025, the disclosures of which are incorporated herein by reference in its entirety for all purposes.

### FIELD

The present disclosure relates generally to a framework through which different transactions associated with different external systems are dynamically processed in parallel through a set of transaction analysis systems to generate insights corresponding to fraud-related patterns detected through processing of the different transactions.

### SUMMARY

Disclosed embodiments provide a framework for processing myriad transactions in real-time through distinct transaction analysis systems, simultaneously and in parallel, to dynamically identify any fraud-related patterns that may be used to generate insights that may be used to enrich these transactions and allow authorization processors to determine, based on these insights, whether to authorize and settle these transactions. According to some embodiments, a computer-implemented method is provided. The computer-implemented method comprises receiving transaction data associated with different transactions pending authorization. The transaction data corresponds to different external systems. The computer-implemented method further comprises processing the transaction data through a set of transaction analysis systems. The transaction data is processed through the set of transaction analysis systems simultaneously and in parallel to obtain fraud-related patterns usable to detect fraudulent transactions. The computer-implemented method further comprises modifying the transaction data to incorporate the fraud-related patterns. The transaction data is modified by updating one or more data fields of the transaction data to include values corresponding to the fraud-related patterns. The computer-implemented method further comprises transmitting the modified transaction data. When the modified transaction data is received at an authorization processor, the authorization processor evaluates the different transactions and the values to generate authorization decisions corresponding to the different transactions according to the fraud-related patterns. The computer-implemented method further comprises obtaining the authorizations decisions and additional fraud-related patterns corresponding to the different transactions. The additional fraud-related patterns are generated according to the authorization decisions. The computer-implemented method further comprises dynamically updating the set of transaction analysis systems according to the authorization decisions and the additional fraud-related patterns to improve generation of new fraud-related patterns from new transaction data.

In some embodiments, the transaction data includes one or more dynamic verification values corresponding to payment instruments used for one or more transactions. Additionally, the computer-implemented method further comprises comparing the one or more dynamic verification values to a set of reference dynamic verification values to generate a subset of the fraud-related patterns.

In some embodiments, processing the transaction data through the set of transaction analysis systems further comprises further comprises comparing a set of pre-authorization records and the transaction data through a pre-authorization query system of the set of transaction analysis systems to obtain a subset of the fraud-related patterns.

In some embodiments, processing the transaction data through the set of transaction analysis systems further comprises processing the transaction data and a set of address verification and identification number rules through a rules query system of the set of transaction analysis systems to generate a subset of the fraud-related patterns.

In some embodiments, the transaction data includes plaintext account identifiers corresponding to different accounts. Additionally, processing the transaction data through the set of transaction analysis systems further comprises processing the plaintext account identifiers through a transactional customer query system of the set of transaction analysis systems to generate a subset of the fraud-related patterns.

In some embodiments, processing the transaction data through the set of transaction analysis systems further comprises querying one or more data sources for fraud-related data and processing the transaction data and the fraud-related data through a data enhancement system of the set of transaction analysis systems to generate a subset of the fraud-related patterns.

In some embodiments, the set of transaction analysis systems include one or more trained machine learning algorithms. Further, the transaction data is processed through the one or more trained machine learning algorithms to generate the fraud-related patterns.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a transactional fraud platform dynamically processes transaction data associated with different transactions, through different transaction analysis systems, to identify fraud-related patterns and insights for detecting fraud in accordance with at least one embodiment;

FIG. 2 shows an illustrative example of an environment in which different transaction analysis systems process, in parallel, transaction data associated with different transactions to identify fraud-related patterns and insights for detecting fraud in accordance with at least one embodiment;

FIG. 3 shows an illustrative example of an environment in which a rules query system implemented through a transactional fraud platform dynamically evaluates transaction data according to address verification and bank identification number (BIN) matching rules to identify fraud-related patterns and insights in accordance with at least one embodiment;

FIG. 4 shows an illustrative example of an environment in which a pre-authorization query system implemented through a transactional fraud platform compares pre-authorization records and transaction data corresponding to different transactions to identify fraud-related patterns and insights in accordance with at least one embodiment;

FIG. 5 shows an illustrative example of an environment in which a transactional customer query system implemented through a transactional fraud platform converts plaintext account numbers into obfuscated account numbers for verification of existing accounts in accordance with at least one embodiment;

FIG. 6 shows an illustrative example of an environment in which a data enhancement system implemented through a transactional fraud platform queries one or more data sources for fraud-related data and processes the fraud-related data to identify fraud-related patterns and insights in accordance with at least one embodiment;

FIG. 7 shows an illustrative example of a process for evaluating transaction data according to applicable address verification and BIN matching rules to identify fraud-related patterns and insights in accordance with at least one embodiment;

FIG. 8 shows an illustrative example of a process for comparing pre-authorization records to transaction data corresponding to different transactions to identify fraud-related patterns and insights in accordance with at least one embodiment;

FIG. 9 shows an illustrative example of a process for translating plaintext account identifiers according to account obfuscation methods to determine the validity of different accounts associated with different transactions in accordance with at least one embodiment;

FIG. 10 shows an illustrative example of a process for evaluating transaction data according to fraud-related data from different data sources to identify fraud-related patterns and insights in accordance with at least one embodiment; and

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments provide a framework through which different transactions associated with different external systems are dynamically processed in parallel through a set of transaction analysis systems to generate transaction authorization decisions and insights corresponding to fraud-related patterns detected through processing of the different transactions. For instance, during a transaction being performed through an external system (e.g., a merchant or retailer system), transaction data associated with the transaction may be transmitted to a payment instrument authorization service for authorization. The payment instrument authorization service may query a transactional fraud platform to process the transaction data in parallel through distinct transaction analysis systems to determine whether the transaction may be authorized and processed by an authorization processor. In some instances, these distinct transaction analysis systems may further evaluate the obtained transaction data and corresponding authorization decisions to detect any fraud-related patterns and generate insights that may be used by the payment instrument authorization service and/or authorization processors to more readily detect potentially fraudulent transactions, thereby minimizing the risk of authorizing such fraudulent transactions.

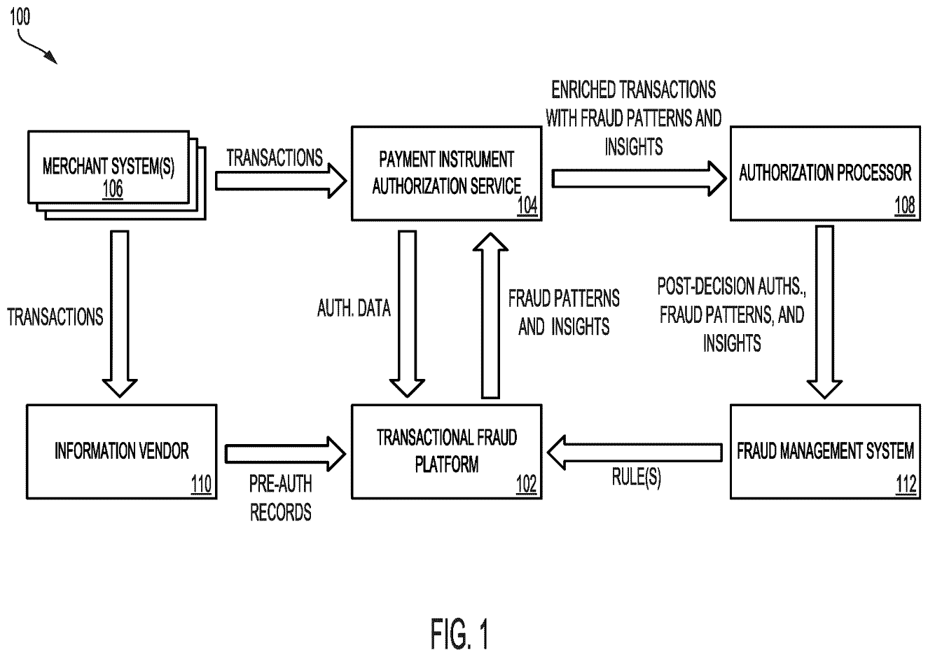

FIG. 1 shows an illustrative example of an environment 100 in which a transactional fraud platform 102 dynamically processes transaction data associated with different transactions, through different transaction analysis systems, to generate transaction authorization decisions, fraud patterns, and insights for detecting fraud in accordance with at least one embodiment. In the environment 100, a payment instrument authorization service 104 receives, in real-time, transaction data corresponding to different transactions occurring through different merchant systems 106. A merchant system 106 may be associated with a merchant or retailer that provides goods and/or service to users. For instance, a merchant system 106 may include a point-of-sale terminal or other computing device implemented at a merchant or retailer location through which a user may provide a payment instrument for a transaction initiated at the merchant or retailer location. The point-of-sale terminal or other computing device may include, for example, a Near Field Communication (NFC) terminal through which a user, through their user device, may initiate a transaction with the corresponding merchant or retailer. Alternatively, a merchant system 106 may include a backend system implemented by a merchant or retailer and that implements an online marketplace that users may access (such as through a browser application executing on a user computing device) to initiate transactions with the merchant or retailer.

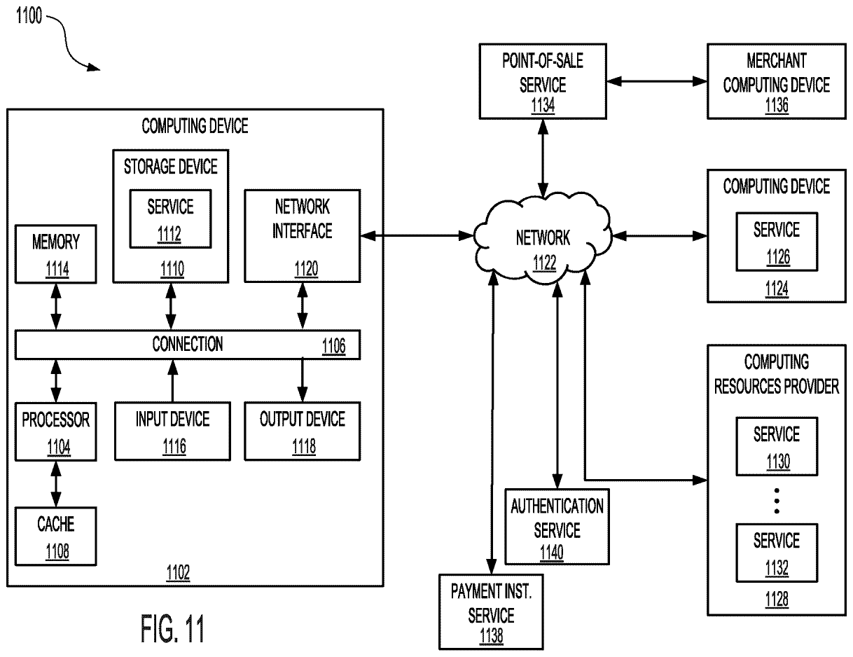

When a user initiates a transaction with a merchant or retailer, a merchant system 106 associated with the merchant or retailer may transmit transaction data to a payment instrument authorization service 104 for processing. The payment instrument authorization service 104, in an embodiment, is a service that, for example, processes transactions associated with payment instruments, processes transactions associated with unsecured payment instruments, processes cancellations of accounts associated with secured and unsecured payment instruments, detects fraudulent account activity, performs different actions in response to fraudulent activity, and performs other such operations. In an embodiment, the payment instrument authorization service 104 is a service such as the service 1112 described herein at least in connection with FIG. 11. In an embodiment, the payment instrument authorization service 104 is a service provided by a computing resource provider such as the computing resource provider 1128 described herein at least in connection with FIG. 11 (e.g., a service such as service 1130 and/or service 1132 described herein at least in connection with FIG. 11). In an embodiment, the payment instrument authorization service 104 is a payment instrument service such as the payment instrument service 1138 described herein at least in connection with FIG. 11. In some instances, the payment instrument authorization service 104 may be a service operated by the issuer of the secured payment instrument and/or the unsecured payment instrument. In some instances, the payment instrument authorization service 104 may be a service operated by a third-party on behalf of the issuer of the secured payment instrument and/or the unsecured payment instrument.

The transaction data transmitted by a merchant system 106 and corresponding to a particular transaction may specify a transaction amount (including the applicable currency), account information corresponding to the payment instrument used for the transaction (e.g., primary account number (PAN), name specified on payment instrument, expiration date of payment instrument, security code of the payment instrument, payment instrument type, etc.), contact information associated with the user, and merchant information (e.g., merchant category code (MCC), merchant name, merchant description, merchant location, merchant contact information, etc.), session identifier corresponding to the transaction, and the device identifier corresponding to the user device (if the transaction was initiated through a user device). In an embodiment, the payment instrument authorization service 104 receives transaction data from a plurality of merchant systems 106 as the corresponding transactions are performed through these merchant systems 106. As there may be a significant number of merchant systems 106 involved in myriad transactions at any given time, the payment instrument authorization service 104 may continuously receive large volumes of data corresponding to these myriad transactions. These transactions, prior to being settled, may require rapid authorization and settlement decisions (e.g., within 125 milliseconds, etc.) from the payment instrument authorization service 104 and an authorization processor 108 such that merchant systems 106 may be notified as to whether a pending transaction has been authorized, return an indication to the user as to whether the transaction has been completed successfully, and obtain payment from an authorization processor 108 for the transaction. Thus, there is a need for the payment instrument authorization service 104 to perform various evaluations of provided transaction data in a short period of time (e.g., within 125 milliseconds, etc.) to generate and provide any insights that may be implemented and used by the authorization processor 108 to determine whether to authorize and settle corresponding transactions.

In an embodiment, the payment instrument authorization service 104 leverages a transactional fraud platform 102 to detect any fraud-related patterns and insights that may be used to enrich transaction data corresponding to different transactions prior to providing this transaction data to an authorization processor 108 for authorization and settlement. The transactional fraud platform 102 may be implemented through a computing resource provider such as the computing resource provider 1128 described herein at least in connection with FIG. 11. As described in greater detail herein, a computing resources provider (such as computing resource provider 1128 described herein in connection with FIG. 11) may provide different services including, but not limited to, data analytics, data storage, archival storage, big data storage, virtual computing (including various scalable VM architectures), blockchain services, containers (e.g., application encapsulation), database services, development environments (including sandbox development environments), e-commerce solutions, security services, serverless hosting, and the like. The resources provided by the computing resource provider may be scalable on demand, whereby additional resources may be dynamically implemented in the event of greater resource demand (e.g., data spikes, more stringent bandwidth requirements to limit latency, etc.). Further, the implementation of the transactional fraud platform 102 through a computing resource provider further enables the payment instrument authorization service 104 to add and/or modify systems of the transactional fraud platform 102 according to the needs of the payment instrument authorization service 104.

In an embodiment, the transactional fraud platform 102 implements a set of transaction analysis systems that can simultaneously and in parallel process transaction data to detect fraud-related patterns based on the obtained transaction data and provide fraud-related insights that may be used to more readily detect fraudulent transactions within authorization decision time restraints (e.g., within 125 milliseconds, etc.) and prior to settlement. As noted above, the transactional fraud platform 102 may be implemented through a computing resource provider, whereby the set of transaction analysis systems may be implemented using scalable resources provided by the computing resource provider. Further, the set of transaction analysis systems may be expanded at any time to implement additional functionalities for fraud detection and for providing additional security layers for accounts associated with the payment instrument authorization service 104.

In an embodiment, the transactional fraud platform 102 includes a query orchestration system that is configured to dynamically receive and distribute transaction data from the payment instrument authorization service 104 to the set of transaction analysis systems for parallel processing of the transaction data. Further, the query orchestration system may consolidate responses from the set of transaction analysis systems for the different transactions and transmit the consolidated responses to the payment instrument authorization service 104. The consolidated responses may include, for instance, any detected fraud-related patterns generated based on evaluation of obtained transaction data and historical transaction data, as well as any fraud-related insights generated based on the fraud-related patterns and other data sources and that may be used to generate fraud-related policies for detecting fraudulent transactions prior to transaction settlement.

The set of transaction analysis systems, in an embodiment, includes a rules query system that dynamically evaluates obtained transaction data according to different applicable rules to identify any fraud-related patterns and insights that may be used to refine the different applicable rules and/or generate new rules that may be applied by the authorization processor 108 to determine whether to authorize and settle incoming transactions. The rules query system, in an embodiment, obtains a set of rule patterns generated based on evaluations of addresses associated with different user accounts and transactions. For instance, the rules query system may query an address verification service implemented by the transactional fraud platform 102 or other entity associated with the transactional fraud platform 102 (e.g., a payment instrument service, etc.) to obtain any rule patterns generated based on ongoing evaluations of transactions for which addresses associated with different user accounts are available.

The address verification service, in an embodiment, processes transaction data from the payment instrument authorization service 104 to extract, from each transaction, an address, an account number (i.e., a PAN), and a client timestamp (i.e., the time at which the transaction was initiated). For a given transaction, the address verification service may attempt to insert the indicated address into a first table, where the indicated address may serve as a primary key. If the address is not present within the first table, the address verification service may insert this address into the first table, as the address may be a new address not previously encountered by the address verification service. However, if the address is already present within the first table, the address verification service may trigger a relational database management system (RDBMS) exception.

If an address RDBMS exception is triggered, the address verification service may attempt to insert the address and the associated account number provided in the corresponding transaction into a second table. This combination of the address and associated account number may serve as a primary key for the second table. If the address verification service determines that the primary key corresponding to the combination of the address and associated account number can be inserted into this second table, the address verification service may add this primary key to the second table as this primary key may represent a new combination of address and account number. Further, within the entry corresponding to this primary key in the second table, the address verification service may incorporate a timestamp corresponding to when the transaction including this address and account number was initiated.

In an embodiment, if the address verification service determines that the primary key is present within the second table, the address verification service increments a counter associated with this primary key in the second table to indicate a new occurrence of the address and account number combination. The counter may correspond to the number of times that the combination of address and account number has been encountered over a pre-defined threshold period of time (e.g., a one-hour period, a two-hour period, etc.) from the timestamp indicated in the entry. As insertion of the primary key into the second table may denote a second occurrence of the address identified by the address verification service, a counter threshold for determining RDBMS exceptions for the second table may be tailored to be one less than the desired address reoccurrence threshold.

The counter threshold implemented for the second table may be defined according to a pre-defined temporal window (e.g., a one-hour window, a two-hour window, etc.) whereby if the counter corresponding to a particular address/account number combination reaches this counter threshold within the pre-defined temporal window (defined with the recorded timestamp as the start of the pre-defined temporal threshold), the address verification service may automatically generate a rule pattern that denotes the existence of potential fraud associated with the address. The address verification service may transmit this rule pattern to the rules query system, which may use this rule pattern to enrich the transaction data corresponding to transactions that include the specified address to indicate that the transaction is potentially fraudulent. This enrichment may include modifying the metadata included in the transaction data to include one or more entries or flags denoting that the transaction may be fraudulent. The rule pattern may incorporate a temporal rule whereby any transaction data corresponding to transactions including the identified address received within a temporal window (e.g., a one-hour window, a two-hour window, etc.) starting from the time of the transaction that triggered the RDBMS exception within the second table are to be enriched to indicate the possible presence of fraud or other suspect activity. Additionally, the address verification service may update the timestamp of the record within the second table to enforce the pre-defined temporal window.

Once the address verification service has transmitted the rule pattern to the rules query system, the address verification service may update the timestamp within the entry corresponding to the address/account number combination to enforce this rule pattern. At the conclusion of the time window for the rule pattern, the address verification service may remove the entries corresponding to the address within the tables implemented by the address verification service. Further, the rules query system may automatically remove the rule pattern and continue processing new transaction data without applying the now-expired rule pattern.

In an embodiment, the rules query system further obtains BIN matching rules from a BIN matching service implemented by a fraud management system 112. These BIN matching rules may be generated by the BIN matching service or an authorization processor 108 based on ongoing evaluations of transactions for which account numbers (e.g., PANs) are provided and that include corresponding BINs. As noted above, a transaction may include an account number, such as PAN, corresponding to an account maintained by a payment instrument service for a particular account holder (e.g., a user). The account number may be defined using a string of alphanumeric characters, whereby a subset of alphanumeric characters may include the BIN associated with the payment instrument service that maintains the account.

BIN matching rules may be defined based on the frequency of transactions including the same BIN, which may denote attempts at BIN hacking or other BIN-related attacks. For instance, a malicious actor may utilize brute-force methods to identify a valid combination of a PAN, an expiration date for the account, and a card verification value (CVV). When a valid combination is found, the malicious actor may try new combinations that rely on the BIN identified from the identified valid combination. To identify a valid combination, a malicious actor may attempt numerous transactions using different combinations of PANs, expiration dates, and CVVs until a combination is identified for which corresponding transactions are authorized by the authorization processor 108.

In some instances, the authorization processor 108 and/or the BIN matching service implemented by the fraud management system 112 may evaluate transaction data corresponding to different transactions to identify any BIN-related patterns that may denote the occurrence of BIN hacking or other BIN-related attack for particular BINs. For instance, if a threshold number of transactions over a pre-defined period of time is rejected for not being associated with a valid account, the authorization processor 108 and/or BIN matching service may determine whether these transactions have reoccurring BINs associated with them. If so, the authorization processor 108 and/or the BIN matching service may define a rule whereby any transactions associated with account numbers having the identified BIN should be subject to greater scrutiny or outright rejected for a period of time. Accordingly, the rules query system may process any obtained transaction data according to this rule to identify any fraud-related patterns and insights that may be used to enrich transaction data prior to the transaction data being provided to the authorization processor 108 for authorization and settlement.

In an embodiment, the rules query system implements a machine learning algorithm or artificial intelligence that is trained to generate fraud-related insights that may be used to further anticipate and detect potentially fraudulent transactions. These fraud-related insights may be generated by processing the transaction data and applicable rules and rule patterns through the trained machine learning algorithm to detect any transaction trends that may be indicative of current fraud. For example, if the BIN matching rules provided by a BIN matching service correspond to BINs associated with a particular account type (e.g., a private label for which a range of BINs may be assigned, etc.), the rules query system may determine that accounts associated with this particular account type may be at greater risk of fraud. This insight may be provided to the payment instrument authorization service 104, which may automatically enrich transactions associated with BINs corresponding to this account type such that these transactions are more greatly scrutinized by the authorization processor 108 prior to authorization and settlement. As another illustrative example, the trained machine learning algorithm may detect that transactions subject to the rule patterns and/or rules include transaction amounts that vary according to the times at which the corresponding transactions were initiated, denoting a transaction pattern that may be used to more readily identify fraudulent transactions. Accordingly, the rules query system may transmit this insight to the payment instrument authorization service 104, which may enrich any transactions that correspond to this identified pattern so that these transactions may be subject to greater scrutiny and/or outright rejected by the authorization processor 108.

In an embodiment, the transactional fraud platform 102 further implements a pre-authorization query system that dynamically evaluates pre-authorization transaction records from one or more information vendors 110 to identify any transaction fraud-related patterns and insights. For instance, through one or more application programming interfaces (APIs), the pre-authorization query system may obtain pre-authorization records generated by an information vendor 110 prior to the merchant systems 106 transmitting transaction data to the payment instrument authorization service 104 for the same transactions.

In some instances, one or more merchant systems 106, prior to transmitting transaction data for a particular transaction to the payment instrument authorization service 104 for authorization, may transmit transaction data corresponding to the particular transaction to an information vendor 110 for evaluation. The information vendor 110 may be a service that contracts with a merchant to analyze transactions in real-time to determine whether these transactions may be submitted for authorization and settlement. The information vendor 110 may utilize machine learning algorithms and/or artificial intelligence to evaluate new transactions and determine whether these transactions may be transmitted for final authorization or should be rejected (such as for fraud).

In an embodiment, through the aforementioned APIs, the pre-authorization query system obtains pre-authorization transaction records generated by the information vendor 110 based on the evaluations performed by the information vendor 110 and corresponding to ongoing transactions associated with one or more merchant systems 106. The pre-authorization transaction records may include transaction data corresponding to these ongoing transactions, as well as any approval/rejection decisions generated by the information vendor 110 based on its evaluation of these ongoing transactions through its own heuristics, machine learning/artificial intelligence systems, or other techniques. The pre-authorization query system may evaluate these pre-authorization transaction records to identify any fraud-related patterns and/or insights associated with these pre-authorization transaction records and corresponding approval/rejection decisions generated by the information vendor 110. For instance, if the information vendor 110 is consistently rejecting transactions associated with particular payment instruments as a result of incorrect CVVs being provided over a short period of time, the pre-authorization query system may determine that these payment instruments may be compromised and, as a result, may generate a fraud-related insight indicating that transactions corresponding to these payment instruments should be rejected or subject to greater scrutiny by the authorization processor 108.

In some instances, the pre-authorization transaction records may be used by the pre-authorization query system to detect any fraud-related patterns and insights without regard to the approval/rejection decisions generated by the information vendor 110. For example, the pre-authorization query system may process the pre-authorization transaction records to perform an initial analysis of the transaction data included in the pre-authorization transaction records to identify any payment instruments for which multiple CVVs, expiration dates, and the like are being provided over a short period of time, denoting possible brute force attempts to access the accounts associated with these payment instruments. This may allow the pre-authorization query system to prepare initial fraud-related patterns and insights based on these transactions prior to the transaction data being provided by the payment instrument authorization service 104. In some instances, the pre-authorization query system may transmit these identified patterns and insights to the payment instrument authorization service 104, which may use these patterns and insights to enrich received transaction data with these patterns and insights. These enrichments may allow the authorization processor 108 to review these transactions subject to the provided patterns and insights in order to more accurately detect fraud and, accordingly, determine whether these transactions may be authorized and settled.

In an embodiment, when the pre-authorization query system receives transaction data from the payment instrument authorization service 104, the pre-authorization query system may compare the transaction data to the previously obtained pre-authorization transaction records to determine whether the transaction data corresponds to any transactions previously processed by the information vendor 110 and for which the pre-authorization query system has identified any fraud-related patterns and/or insights. For example, the pre-authorization query system may compare one or more characteristics of the PAN corresponding to a payment instrument and specified in the obtained transaction data to the PANs indicated in the pre-authorization transaction records to determine whether the same payment instrument was used for a transaction processed by the information vendor 110 and obtained by the payment instrument authorization service 104 from a merchant system 106. For example, the pre-authorization query system may use a set of PAN values corresponding to a payment instrument to query the pre-authorization transaction records to determine whether the payment instrument indicated in the transaction data was used for a transaction processed by the information vendor 110. If the pre-authorization query system identifies one or more pre-authorization transaction records corresponding to a payment instrument indicated in the obtained transaction data, the pre-authorization query system may determine whether any of the identified pre-authorization transaction records indicate the same transaction amount as that in the obtained transaction data. If so, the pre-authorization query system may determine whether the transaction data corresponding to the matching payment instrument and transaction amount was obtained within a pre-defined period of time from the preliminary authorization decision generated by the information vendor 110 (e.g., five seconds, ten seconds, etc.).

If the pre-authorization query system determines that the transaction data corresponding to a particular payment instrument and transaction matches a preliminary transaction record corresponding to a transaction previously processed by the information vendor 110, the pre-authorization query system may return, to the payment instrument authorization service 104, any previously identified fraud-related patterns and insights corresponding to the payment instrument and the transaction. Alternatively, if the pre-authorization query system determines that the transaction data does not correspond to any previously obtained pre-authorization transaction records, the pre-authorization query system may forego providing any fraud-related patterns or insights, as none have been created for the payment instrument. In some instances, the pre-authorization query system may return an indication that no fraud-related patterns or insights were identified for the payment instrument and the corresponding transaction.

In an embodiment, the transactional fraud platform 102 further implements a transactional customer query system that encrypts or tokenizes account numbers associated with different payment instruments in order to securely store these account numbers within the payment instrument service systems. The encryption or tokenization of these account numbers may prevent any unauthorized entity from accessing the corresponding accounts through the payment instrument service. For instance, if a malicious entity gains access to the plaintext account number associated with a payment instrument (e.g., the PAN associated with a payment instrument, etc.), the malicious entity may not have access to the cryptographic keys or seeds necessary to obtain the encrypted or tokenized value associated with the payment instrument and usable to access the account.

When a new payment instrument account is generated by the payment instrument service, the transactional customer query system implemented by the transactional fraud platform 102 may automatically process the plaintext account number associated with the new payment instrument through a custom obfuscation processor to generate an obfuscated account number that may be stored by the transactional fraud platform 102. Thus, the transactional fraud platform 102 may store only the obfuscated account numbers for different payment instrument accounts and the obfuscated account numbers (as opposed to the plaintext PANs) may be used to access these payment instrument accounts for generating transaction authorization decisions.

The transactional customer query system may receive and process the transaction data from the payment instrument authorization service 104 to extract the plaintext account numbers associated with the payment instruments used in the corresponding transactions. The transactional customer query system may encrypt or tokenize these plaintext account numbers to obtain corresponding obfuscated account numbers that may be evaluated to determine whether these obfuscated account numbers correspond to existing accounts maintained by the payment instrument service. If there are any mismatches (e.g., an obfuscated account number does not correspond to an active account, etc.), the transactional customer query system may transmit an indication that there are no patterns or insights associated with the obfuscated account numbers. Accordingly, the payment instrument authorization service 104 may proceed to perform any actions related to a failure to identify existing accounts associated with the one or more obfuscated account numbers.

Alternatively, if the transactional customer query system, for a particular obfuscated account number, determines that the obfuscated account number corresponds to an existing payment instrument account, the account obfuscation query system may evaluate the valid account (as well as any other valid accounts associated with pending transactions) to identify any usage patterns. As noted above, the transactional customer query system may evaluate any identified active accounts to determine whether these active accounts are subject to any fraud-related alerts or other actions (e.g., an account is frozen on account of detected fraudulent activity, etc.). For any accounts that are subject to a fraud-related alert or other action, the transactional customer query system may evaluate these active accounts through one or more machine learning algorithm or artificial intelligence processes to identify any common account and/or transaction characteristics that may be used to derive any fraud-related patterns or insights that may be used to enrich the corresponding transactions and other transactions that may share these common account and/or transaction characteristics. For instance, if the transactional customer query system, through processing of transactions and corresponding payment instrument accounts through the trained machine learning algorithm or artificial intelligence identifies payment instruments for which multiple invalid PANs are being provided over a short period of time, the transactional customer query system may determine that valid payment instruments sharing certain characteristics with these invalid PANs (e.g., similar BINs, associated with the same private label, etc.) may be the target of possible brute force attempts to access the payment instrument accounts associated with these payment instruments. This fraud-related insight may allow for real-time generation of authorization decisions for transactions having the identified account characteristics.

In an embodiment, the transactional fraud platform 102 further implements a data enhancement system that automatically queries one or more different data sources to obtain fraud-related data that may be used to identify any fraud-related patterns and insights usable by the authorization processor 108 to make transaction authorization decisions. The one or more different data sources may include credit bureaus or reporting agencies that may track credit and fraud reports associated with different individuals. Further, the one or more data sources may include government agencies or other fraud monitoring agencies that may monitor and report any fraud-related incidents to different entities and/or the general public. The one or more data sources may further include data repositories and other systems maintained by the payment instrument authorization service 104 and/or the transactional fraud platform 102. For example, the payment instrument authorization service 104 and/or the transactional fraud platform 102 may maintain data corresponding to fraud-related incidents detected by the payment instrument authorization service 104 and/or the transactional fraud platform 102 based on user communications, actions taken in response to detecting fraudulent activity, and the like. In an embodiment, the data enhancement system processes the obtained fraud-related data through a machine learning algorithm or artificial intelligence to identify any fraud-related patterns or insights that may be used to enrich incoming transaction data corresponding to different transactions.

The machine learning algorithm or artificial intelligence implemented by the data enhancement system may be trained using a dataset of sample data (e.g., press releases, fraud alerts and notifications, credit reports, etc.) and sample fraud-related patterns and insights corresponding to the sample data (e.g., historical fraud-related patterns and insights, hypothetical fraud-related patterns and insights, combinations of historical and hypothetical fraud-related patterns and insights, etc.). This dataset may be analyzed by the machine learning algorithm or artificial intelligence by converting the sample data into a set of data embeddings and the sample fraud-related patterns and insights into a set of fraud-related embeddings. The machine learning algorithm or artificial intelligence may classify the sample data according to one or more vectors of similarity between the set of data embeddings and the set of fraud-related embeddings. In some instances, the machine learning algorithm or artificial intelligence may be implemented with a threshold that may be used to determine, based on the aforementioned embeddings and the one or more vectors of similarity, whether sample data is sufficiently similar (e.g., satisfies the threshold by having a requisite amount of embeddings being within a level of tolerance of corresponding fraud-related embeddings for a particular known pattern and/or insight) to a particular sample fraud-related pattern and/or insight. If a sample data point does not satisfy the required threshold for classification to a particular known fraud-related pattern or insight, the machine learning algorithm or artificial intelligence may be trained to determine that no fraud-related pattern or insight can be derived from the sample data point.

In an embodiment, through the machine learning algorithm or artificial intelligence, the data enhancement system may perform such clustering or classification of different data as the data is received by different data sources. Through this processing of the different data, the data enhancement system may obtain partial matches among different known fraud-related patterns and/or insights to detect any fraud-related patterns and/or insights corresponding to the obtained data and that may be used to process obtained transaction data. Further, if evaluation of embeddings of a particular data fails to satisfy the aforementioned threshold for identification of a fraud-related pattern and/or insight that may be used to detect fraudulent transactions, the machine learning algorithm or artificial intelligence may automatically process transaction data according to other known fraud-related patterns and insights. Example classification and/or clustering algorithms that may be implemented include Support Vector Machines (SVM), k-Nearest Neighbor (KNN) algorithms, logistic regression algorithm, random forest models, Naïve Bayes models, linear regression models, decision tree models, gradient boosting machine models, and the like.

As noted above, the transactional fraud platform 102 may be implemented using scalable resources provided by a computing resource provider, which allows for expansion of the set of transaction analysis systems to implement additional functionalities for fraud detection and for providing additional security layers for accounts associated with the payment instrument authorization service 104. For example, in an embodiment, the transactional fraud platform 102 implements a dynamic verification value evaluation microservice that is configured to automatically, and in real-time or near real-time, evaluate any transaction data submitted by different merchant systems 106 as the transaction data is received to determine whether any included dynamic verification values are valid. In an embodiment, the dynamic verification value evaluation microservice allows users to enroll their payment instruments for generation of dynamic verification values that may be used as a substitute for the static verification values printed or otherwise presented on the users' payment instruments.

If a payment instrument is to be enrolled for generation of dynamic verification values, a payment instrument service application implemented on a user's computing device dynamically generates a secret code that, along with record data associated with the payment instrument, may be used as input to a dynamic verification value generation algorithm implemented by the payment instrument service application to generate dynamic verification codes for the payment instrument. The secret code may be generated by the payment instrument service application using the dynamic verification value generation algorithm. The secret code may be a statistically unique identifier that may serve as a verification value seed for the generation of dynamic verification values. Alternatively, in some instances, the secret code may be a shared secret established between the payment instrument service application and the payment instrument service, which implements the transactional fraud platform 102, through a secure communications channel and a symmetric-key algorithm, a Diffie-Hellman key exchange scheme, or any other suitable cryptographic method.

If the payment instrument service application generates a new secret code for the payment instrument, the payment instrument service application may automatically transmit a request, through an API exposed by the payment instrument service, to the dynamic verification value code microservice to associate the payment instrument with this secret code within the user record corresponding to the user. This request (e.g., API call) may include any available record data associated with the payment instrument and the newly generated secret code. In response to the request from the payment instrument service application, the dynamic verification value code microservice may determine whether the user record associated with the particular payment instrument is associated with an existing secret code previously generated for the payment instrument. If the dynamic verification value code microservice determines that the user record corresponding to the user and associated with the payment instrument persists an existing secret code, the dynamic verification value code microservice may return a failure code that serves as an indication that dynamic verification values cannot be generated for the payment instrument. If the user record does not persist an existing secret code for the payment instrument, the dynamic verification value code microservice may store the unique identifier associated with the payment instrument and the secret code in the user record. In some instances, the unique identifier associated with the payment instrument may be obfuscated to prevent inadvertent exposure of the unique identifier to unauthorized entities. Additionally, the dynamic verification value code microservice may transmit a response that includes a success code or other indication that the payment instrument is successfully enrolled for generation of dynamic verification values.

When the dynamic verification value code microservice receives transaction data corresponding to a particular transaction from the payment instrument authorization service 104, the dynamic verification value code microservice may to determine whether a secret code corresponding to the payment instrument used for the particular transaction is maintained within the user record associated with the payment instrument. If the dynamic verification value evaluation microservice is unable to identify a user record corresponding to the payment instrument, the dynamic verification value evaluation microservice may determine that the payment instrument has not been enrolled for implementation of dynamic verification values. Accordingly, the dynamic verification value evaluation microservice may be unable to validate the provided dynamic verification value provided in the transaction data. This may cause the dynamic verification value evaluation microservice to perform a process corresponding to a missing valid dynamic verification value. For example, in some instances, the dynamic verification value evaluation microservice may automatically enrich the transaction to indicate that the transaction could not be vetted by the transactional fraud platform 102. This may cause the authorization processor 108 to more greatly scrutinize the transaction and/or outright reject the transaction. Alternatively, the dynamic verification value evaluation microservice may transmit the transaction data corresponding to this transaction to another microservice or system implemented by the transactional fraud platform 102 for further evaluation of the authorization request. For example, the dynamic verification value evaluation microservice may transmit the transaction data to the rules query system, which may process the transaction data according to any applicable rules to determine whether the present instrument utilization is likely fraudulent or authentic. Based on this determination, the rules query system may enrich the particular transaction to indicate whether the transaction satisfied the applicable rules or violated any of these applicable rules. This enrichment of the transaction may allow the authorization processor 108 to perform additional evaluation of the transaction and determine whether to authorize and settle the transaction.

In an embodiment, if the user record corresponding to the payment instrument includes a secret code, the dynamic verification value evaluation microservice may process the secret code, a portion of the unique identifier corresponding to the payment instrument, and the time interval corresponding to when the instrument utilization was generated as input to a hashing algorithm to generate a reference dynamic verification value for the payment instrument. Once the dynamic verification value evaluation microservice has generated a reference dynamic verification value for the payment instrument, the dynamic verification value evaluation microservice may compare the dynamic verification value provided in the transaction data for the transaction to this newly generated reference dynamic verification value. If the dynamic verification value evaluation microservice determines that the dynamic verification value does not match the reference dynamic verification value, the dynamic verification value evaluation microservice may determine whether the provided dynamic verification value matches the actual static verification value presented on the payment instrument. If the dynamic verification value provided in the authorization request does not match either the reference dynamic verification value or the static verification value for the payment instrument, the dynamic verification value evaluation microservice may automatically perform a process corresponding to a missing valid dynamic verification value for the transaction. This process, in some instances, may cause the dynamic verification value evaluation microservice to automatically enrich the transaction to indicate that the transaction could not be vetted by the transactional fraud platform 102. Alternatively, this process may cause the dynamic verification value evaluation microservice to transmit the authorization request to another microservice or system implemented by the transactional fraud platform 102, which may process the transaction data to determine whether the present transaction is fraudulent or authentic, as described above.

If the dynamic verification value provided in the transaction data for the particular transaction matches the reference dynamic verification value generated by the dynamic verification value evaluation microservice, the dynamic verification value evaluation microservice may execute a process corresponding to the successful validation of a provided dynamic verification value for a payment instrument. For example, in some instances, this process may cause the dynamic verification value evaluation microservice to automatically transmit a response to the payment instrument authorization service 104, which may enrich the transaction to indicate that the transaction is associated with a valid dynamic verification value. This may cause the authorization processor 108 to determine that the transaction may be authorized and settled. In some instances, the process, when executed, may cause the dynamic verification value evaluation microservice to transmit the transaction data to another microservice or system implemented by the transactional fraud platform 102 for further evaluation of the transaction data. Based on the determinations of the different systems and microservices implemented by the transactional fraud platform 102, the payment instrument authorization service 104 may enrich the corresponding transaction data to provide any identified fraud-related patterns and insights to the authorization processor 108. The authorization processor 108 may evaluate the provided fraud-related patterns and insights for each transaction to determine whether to authorize and settle the transaction.

In an embodiment, the authorization processor 108 further provides post-decision authorization data, fraud patterns, and fraud-related insights generated by the authorization processor 108 based on transaction data provided by the payment instrument authorization service 104 and other transactions processed by the authorization processor 108 without payment instrument authorization service 104 intervention (e.g., transactions corresponding to payment instruments not associated with the payment instrument authorization service 104, etc.). For instance, the authorization processor 108 may process any obtained transaction data according to any fraud-related patterns and insights provided by the payment instrument authorization service 104 to determine whether the corresponding transactions may be authorized and settled. Additionally, the authorization processor 108, in some instances, may implement its own heuristics, machine learning/artificial intelligence systems, or other techniques to independently evaluate obtained transaction data (such as transaction data corresponding to payment instruments not associated with the payment instrument authorization service 104) and generate its own authorization and settlement decisions. Further, based on these independent evaluations of obtained transaction data (whether obtained from the payment instrument authorization service 104 or other sources), the authorization processor 108 may independently identify different fraud-related patterns and/or insights according to its authorization decisions. The authorization processor 108 may thus provide these post-decision authorizations, as well as any newly generated fraud patterns and/or insights to the transactional fraud platform 102.

In an embodiment, the transactional fraud platform 102 may use the obtained post-decision authorizations and the fraud patterns and/or insights generated by the authorization processor 108 to improve the functionality of the various transaction analysis systems in further identifying new fraud-related patterns and insights based on evaluation of new transactions. For instance, the transactional fraud platform 102 may update the datasets corresponding to the different machine learning algorithms and artificial intelligence processes implemented by the different transaction analysis systems to incorporate additional data points corresponding to transactions for which the authorization processor 108 has generated different authorization and settlement decisions. Furthermore, these additional data points may incorporate any fraud-related patterns and/or insights independently generated by the authorization processor 108, as well as any indications corresponding to the accuracy of the different fraud-related patterns and insights identified by the various transaction analysis systems. These updated datasets may be processed by the different machine learning algorithms and artificial intelligence processes implemented by the different transaction analysis systems to dynamically retrain and/or reinforce these machine learning algorithms and artificial intelligence, which may result in better identification of fraud-related patterns and insights based on evaluation of myriad incoming transactions in real-time as these transactions are received by the transactional fraud platform 102.

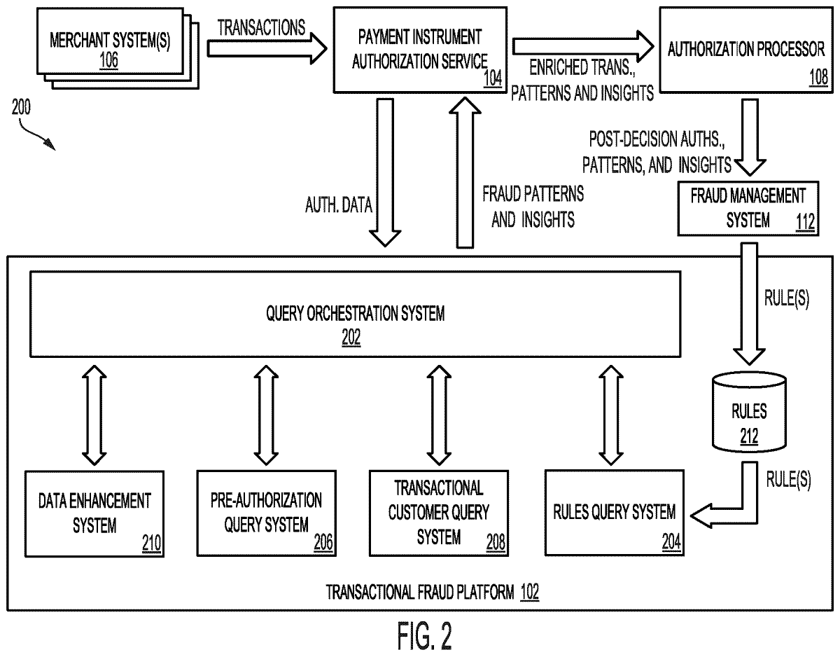

FIG. 2 shows an illustrative example of an environment 200 in which different transaction analysis systems process, in parallel, transaction data associated with different transactions to generate fraud-related patterns and insights for detecting fraud in accordance with at least one embodiment. In the environment 200, a payment instrument authorization service 104 receives, in real-time, transaction data corresponding to different transactions occurring through different merchant systems 106. As noted above, when a user initiates a transaction with a merchant or retailer, a merchant system 106 associated with the merchant or retailer may transmit transaction data to the payment instrument authorization service 104 for processing and to identify any fraud-related patterns and insights that may be used by the authorization processor 108 to determine whether to authorize and settle this transaction. The transaction data transmitted by a merchant system 106 and corresponding to a particular transaction may specify a transaction amount (including the applicable currency), account information corresponding to the payment instrument used for the transaction (e.g., a PAN, name specified on payment instrument, expiration date of payment instrument, security code of the payment instrument, payment instrument type, etc.), contact information associated with the user, and merchant information (e.g., a MCC, merchant name, merchant description, merchant location, merchant contact information, etc.), session identifier corresponding to the transaction, and the device identifier corresponding to the user device (if the transaction was initiated through a user device). In an embodiment, the payment instrument authorization service 104 receives transaction data from a plurality of merchant systems 106 as the corresponding transactions are performed through these merchant systems 106. As there may be a significant number of merchant systems 106 involved in myriad transactions at any given time, the payment instrument authorization service 104 may continuously receive large volumes of data corresponding to these myriad transactions.

As noted above, the payment instrument authorization service 104 may leverage a transactional fraud platform 102 to detect any fraud-related patterns and identify different fraud-related insights that may be processed by the authorization processor 108 to determine whether to authorize and settle pending transactions. In an embodiment, and as illustrated in FIG. 2, the transactional fraud platform 102 implements a query orchestration system 202 that dynamically replicates and transmits transaction data corresponding to different transactions to a set of transaction analysis systems 204-210 that can simultaneously and in parallel process transaction data to detect fraud-related patterns based on the obtained transaction data and provide fraud-related insights that may be used to more readily detect fraudulent transactions within authorization decision time restraints (e.g., within 125 milliseconds, etc.) and prior to settlement by the authorization processor 108. Further, the query orchestration system 202 may consolidate responses from the set of transaction analysis systems 204-210 for these different transactions and transmit the consolidated responses to the payment instrument authorization service 104. The consolidated responses may include, for instance, any detected fraud-related patterns generated based on evaluation of obtained transaction data and historical transaction data and any fraud-related insights generated based on the fraud-related patterns and other data sources, and that may be used to generate fraud-related policies for detecting fraudulent transactions prior to transaction settlement. The payment instrument authorization service 104 may further enrich applicable transactions with these fraud-related patterns and insights, which may be used by the authorization processor 108 to determine whether to authorize and settle these transactions. As noted above, the transactional fraud platform 102 may be implemented through a computing resource provider, whereby the set of transaction analysis systems may be implemented using scalable resources provided by the computing resource provider. Further, the set of transaction analysis systems may be expanded at any time to implement additional functionalities for fraud detection and for providing additional security layers for accounts associated with the payment instrument authorization service 104.

As illustrated in FIG. 2, the transactional fraud platform 102 includes a rules query system 204 that is configured to dynamically evaluate transaction data obtained from the query orchestration system 202 and according to different applicable rules to identify any fraud-related patterns and insights that may be used to refine the different applicable rules and/or generate new rules that may be applied by the authorization processor 108 to make authorization and settlement decisions. In an embodiment, the rules query system 204 queries a rules datastore 212 to obtain a set of rule patterns generated based on evaluations of addresses associated with different user accounts and transactions. For instance, an address verification service implemented by the transactional fraud platform 102 or other entity associated with the transactional fraud platform 102 (e.g., a payment instrument service, etc.) may dynamically generate different rule patterns generated based on ongoing evaluations of transactions for which addresses associated with different user accounts are available. As the address verification service generates these different rule patterns, the address verification service may store these rule patterns within the rules datastore 212. The rules query system 204 may periodically or in response to a triggering event (e.g., indication that new rule patterns have been added to the rules datastore 212, etc.) query the rules datastore 212 to obtain any newly generated rule patterns that may be used to enrich new transactions.

In an embodiment, the rules query system 204 further obtains BIN matching rules from the rules datastore 212. The BIN matching rules may be generated by a BIN matching service implemented by a fraud management system 112, as described above. These BIN matching rules may be generated by the BIN matching service or an authorization processor 108 based on ongoing evaluations of transactions for which account numbers (e.g., PANs) are provided and that include corresponding BINs. As noted above, a transaction may include an account number, such as PAN, corresponding to an account maintained by a payment instrument service for a particular account holder (e.g., a user). The account number may be defined using a string of alphanumeric characters, whereby a subset of alphanumeric characters may include the BIN associated with the payment instrument service that maintains the account. BIN matching rules may be defined based on the frequency of transactions including the same BIN, which may denote attempts at BIN hacking or other BIN-related attacks.

As noted above, the rules query system 204 implements a machine learning algorithm or artificial intelligence that is trained to identify fraud-related patterns and generate fraud-related insights that may be used to detect fraudulent transactions. These fraud-related patterns and insights may be identified by processing the transaction data and the applicable rules and rule patterns from the rules datastore 212 through the trained machine learning algorithm to detect any transaction trends that may be indicative of current fraud. Returning to an earlier illustrative example, if the BIN matching rules provided by a BIN matching service are generated as a result of different transactions being rejected by the authorization processor 108, and the BINs corresponding to these rejected transactions are associated with a particular account type (e.g., a private label for which a range of BINs may be assigned, etc.), the rules query system 204 may determine that accounts associated with this particular account type may be at greater risk of fraud. This fraud-related insight may be provided to the payment instrument authorization service 104, which may generate a policy whereby transactions associated with BINs corresponding to this account type are to be enriched with an indication that these transactions should be more greatly scrutinized by the authorization processor 108 prior to authorization and settlement. As another illustrative example, the trained machine learning algorithm may detect that the rejected transactions include transaction amounts that vary according to the times at which the corresponding transactions were initiated, denoting a fraud-related pattern that may be used to more readily identify fraudulent transactions. Accordingly, the rules query system 204 may transmit this fraud-related insight to the payment instrument authorization service 104, which may generate a policy whereby transactions that correspond to this identified fraud-related pattern may be enriched with an indication that these transactions should be more greatly scrutinized and/or outright rejected by the authorization processor 108.

The machine learning algorithm or artificial intelligence implemented by the rules query system 204 may be trained using a dataset of sample transaction data (e.g., historical transaction data, hypothetical transaction data, combinations of historical and hypothetical transaction data, etc.), sample rules and rule patterns (e.g., historical rules and rule patterns, hypothetical rules and rule patterns, combinations of historical and hypothetical rules and rule patterns, etc.), and sample fraud-related patterns and insights (e.g., known patterns and insights corresponding to the sample transaction data and the sample rules and rule patterns, etc.). The machine learning algorithm or artificial intelligence may be initialized with a first set of values corresponding to different hyperparameters or other coefficients that, in combination, are used to derive an output given a sample input (e.g., sample transaction data and corresponding sample rules and rule patterns). For instance, the rules query system 204 may initialize a set of coefficients or other hyperparameters randomly according to a Gaussian distribution with low variance centered around zero. Using this initial iteration of the machine learning algorithm or artificial intelligence, the rules query system 204 may process the dataset of sample transaction data and sample rules and rule patterns to generate an output. This output may include different fraud-related patterns and insights generated from the transaction data. The machine learning algorithm or artificial intelligence may compare the output (e.g., predicted fraud-related patterns and insights) to the expected fraud-related patterns and insights included in the dataset. Based on this comparison, the machine learning algorithm or artificial intelligence may dynamically update the values corresponding to the different hyperparameters or other coefficients and again process the dataset to generate new outputs. This process may be repeated numerous times until an iteration of the machine learning algorithm or artificial intelligence is obtained that satisfies one or more accuracy or predictability thresholds.

As the rules query system 204 generates, based on the obtained transaction data and applicable rules and rule patterns, different fraud-related patterns and insights, the rules query system 204 may transmit these fraud-related patterns and insights to the query orchestration system 202. The query orchestration system 202 may provide the fraud-related patterns and insights to the payment instrument authorization service 104. Based on the provided fraud-related patterns and insights, the payment instrument authorization service 104 may generate one or more policies whereby transactions that correspond to identified fraud-related patterns or otherwise comport with the provided fraud-related insights may be enriched to include these fraud-related patterns and insights. The authorization processor 108, as noted above, may process the corresponding transaction according to these fraud-related patterns and insights to determine whether to authorize and settle the transaction.

As illustrated in FIG. 2, the transactional fraud platform 102 further implements a pre-authorization query system 206 that dynamically evaluates pre-authorization transaction records from one or more information vendors to identify any fraud-related patterns and insights that may be used by the authorization processor 108 to generate transaction authorization and settlement decisions. In an embodiment, the pre-authorization query system 206, through one or more APIs, obtains pre-authorization transaction records generated by an information vendor prior to the merchant systems 106 transmitting transaction data to the payment instrument authorization service 104 for the same transactions. For instance, the pre-authorization query system 206, through an API exposed by an information vendor, may transmit a GET API call to the information vendor to obtain pre-authorization transaction records corresponding to transactions initially evaluated by the information vendor. In some instances, the pre-authorization query system 206 and the information vendor may maintain a data feed through which pre-authorization transaction records generated by the information vendor may be automatically transmitted, or pushed, to the pre-authorization query system 206.

As noted above, the pre-authorization transaction records obtained from the information vendor may include transaction data corresponding to ongoing transactions, as well as any approval/rejection decisions generated by the information vendor based on its evaluation of these ongoing transactions through its own heuristics, machine learning/artificial intelligence systems, or other techniques. The pre-authorization query system 206 may evaluate these pre-authorization transaction records to identify any fraud-related patterns and/or insights associated with these pre-authorization transaction records and corresponding approval/rejection decisions generated by the information vendor. For instance, if the information vendor is consistently rejecting transactions associated with particular payment instruments as a result of incorrect CVVs being provided over a short period of time, the pre-authorization query system 206 may determine that these payment instruments may be compromised and, as a result, any transactions associated with these payment instruments should be scrutinized to a greater degree by the authorization processor 108. Accordingly, the pre-authorization query system 206 may generate an initial fraud-related pattern and/or insight corresponding to these CVVs that may be used to enrich transactions associated with payment instruments including these CVVs.

In an embodiment, the pre-authorization query system 206 processes the pre-authorization transaction records from the information vendor to detect any fraud-related patterns and insights without regard to the approval/rejection decisions generated by the information vendor. For instance, the pre-authorization query system 206 may process the obtained pre-authorization transaction records through a trained machine learning algorithm or artificial intelligence to perform an initial analysis of the transaction data included in the pre-authorization transaction records and identify fraud-related patterns and/or insights associated with these transactions. For instance, if the pre-authorization query system 206, through processing of pre-authorization transaction records through the trained machine learning algorithm or artificial intelligence, identifies payment instruments for which multiple CVVs, expiration dates, and the like are being provided over a short period of time, the pre-authorization query system 206 may determine that these payment instruments may be the target of possible brute force attempts to access the accounts associated with these payment instruments. This fraud-related insight may allow the pre-authorization query system 206 to independently detect potential fraud associated with these transactions prior to the transaction data being provided by the payment instrument authorization service 104 through the query orchestration system 202.

When the pre-authorization query system 206 obtains transaction data from the query orchestration system 202, the pre-authorization query system 206 may compare the transaction data to the previously obtained pre-authorization transaction records to determine whether the transaction data corresponds to any transactions previously processed by the information vendor and for which the pre-authorization query system 206 has identified any fraud-related patterns and/or insights. For example, the pre-authorization query system 206 may compare one or more characteristics of the PAN associated with a payment instrument specified in the obtained transaction data to the PANs indicated in the pre-authorization transaction records to determine whether the same payment instrument was used for a transaction previously processed by the information vendor and obtained by the payment instrument authorization service 104 from a merchant system 106. Returning to an earlier illustrative example, the pre-authorization query system 206 may use a set of PAN values corresponding to a payment instrument to query the pre-authorization transaction records to determine whether the payment instrument indicated in the transaction data was used for a transaction processed by the information vendor. If the pre-authorization query system 206 identifies one or more pre-authorization transaction records corresponding to a payment instrument indicated in the obtained transaction data, the pre-authorization query system 206 may determine whether any of the identified pre-authorization transaction records specify the same transaction amount as that in the obtained transaction data. If so, the pre-authorization query system 206 may determine whether the transaction data corresponding to the matching payment instrument and transaction amount was obtained within a pre-defined period of time from the preliminary authorization decision generated by the information vendor 110 (e.g., five seconds, ten seconds, etc.). If the pre-authorization query system 206 determines that a transaction satisfies these previous analyses, the pre-authorization query system 206 may determine that the transaction specified in the obtained transaction data corresponds to a transaction previously processed by the information vendor.

If the pre-authorization query system 206 determines that the transaction data corresponding to a particular payment instrument and transaction matches a preliminary transaction record corresponding to a transaction previously processed by the information vendor 110, the pre-authorization query system 206 may return, to the payment instrument authorization service 104 and through the query orchestration system 202, any previously identified fraud-related patterns and insights corresponding to the payment instrument and the transaction. Alternatively, if the pre-authorization query system 206 determines that the transaction data does not correspond to any previously obtained pre-authorization transaction records, the pre-authorization query system 206 may forego providing any fraud-related patterns or insights, as none have been created for the payment instrument. In some instances, the pre-authorization query system 206, through the query orchestration system 202, may return an indication that no fraud-related patterns or insights were identified for the payment instrument and the corresponding transaction.

As illustrated in FIG. 2, the transactional fraud platform 102 further implements transactional customer query system 208 that is configured to encrypt or tokenize account numbers associated with different payment instruments to securely store these account numbers within the payment instrument service systems. As noted above, when a new payment instrument account is generated by the payment instrument service, the transactional customer query system 208 implemented by the transactional fraud platform 102 may automatically process the plaintext account number associated with the new payment instrument through a custom obfuscation processor to generate an obfuscated account number that may be stored by the transactional fraud platform 102. Thus, the transactional fraud platform 102 may store only the obfuscated account numbers for different payment instrument accounts and the obfuscated account numbers (as opposed to the plaintext PANs) may be used to access these payment instrument accounts for generating transaction authorization decisions.

The transactional customer query system 208 may receive and process the transaction data from the query orchestration system 202 to extract the plaintext account numbers associated with the payment instruments used in the corresponding transactions. The transactional customer query system 208 may encrypt or tokenize these plaintext account numbers to obtain corresponding obfuscated account numbers that may be evaluated to determine whether these obfuscated account numbers correspond to existing accounts maintained by the payment instrument service. If there any mismatches (e.g., an obfuscated account number does not correspond to an active account, etc.), the transactional customer query system 208 transmit an indication to the query orchestration system 202 that there are no patterns or insights associated with the obfuscated account numbers. The query orchestration system 202 may transmit this indication to the payment instrument authorization service 104, which may proceed to perform any actions related to a failure to identify existing accounts associated with the one or more obfuscated account numbers.

Alternatively, if the transactional customer query system 208, for a particular obfuscated account number, determines that the obfuscated account number corresponds to an existing payment instrument account, the account obfuscation query system may evaluate the valid account (as well as any other valid accounts associated with pending transactions) to identify any usage patterns. As noted above, the transactional customer query system 208 may evaluate any identified active accounts to determine whether these active accounts are subject to any fraud-related alerts or other actions. For any accounts that are subject to a fraud-related alert or other action, the transactional customer query system 208 may evaluate these active accounts through one or more machine learning algorithm or artificial intelligence processes to identify any common account and/or transaction characteristics that may be used to derive any fraud-related patterns or insights that may be used to enrich the corresponding transactions and other transactions that may share these common account and/or transaction characteristics.

The transactional fraud platform 102 further implements a data enhancement system 210 that automatically queries one or more data sources (including external data sources and data sources maintained by the payment instrument service) to obtain fraud-related data that may be used to identify any fraud-related patterns and insights usable by the authorization processor 108 to make transaction authorization decisions. As noted above, the one or more data sources may include credit bureaus or reporting agencies that may track credit and fraud reports associated with different individuals. Further, the one or more data sources may include government agencies or other fraud monitoring agencies that may monitor and report any fraud-related incidents to different entities and/or the general public. The one or more data sources may further include data repositories and other systems maintained by the payment instrument authorization service 104 and/or the transactional fraud platform 102. For example, the payment instrument authorization service 104 and/or the transactional fraud platform 102 may maintain data corresponding to fraud-related incidents detected by the payment instrument authorization service 104 and/or the transactional fraud platform 102 based on user communications, actions taken in response to detecting fraudulent activity, and the like.

As noted above, the data enhancement system 210 may implement a machine learning algorithm or artificial intelligence that is trained to identify any fraud-related patterns or insights from any data obtained from these data sources. The machine learning algorithm or artificial intelligence may be trained using a dataset of sample data (e.g., press releases, fraud alerts and notifications, credit reports, etc.) and sample fraud-related patterns and insights corresponding to the sample data (e.g., historical fraud-related patterns and insights, hypothetical fraud-related patterns and insights, combinations of historical and hypothetical fraud-related patterns and insights, etc.). This dataset may be analyzed by the machine learning algorithm or artificial intelligence by converting the sample data into a set of data embeddings and the sample fraud-related patterns and insights into a set of fraud-related embeddings. The machine learning algorithm or artificial intelligence may classify the sample data according to one or more vectors of similarity between the set of data embeddings and the set of fraud-related embeddings. In some instances, the machine learning algorithm or artificial intelligence may be implemented with a threshold that may be used to determine, based on the aforementioned embeddings and the one or more vectors of similarity, whether sample data is sufficiently similar (e.g., satisfies the threshold by having a requisite amount of embeddings being within a level of tolerance of corresponding fraud-related embeddings for a particular known pattern and/or insight) to a particular sample fraud-related pattern and/or insight. If a sample data does not satisfy the required threshold for classification to a particular known fraud-related pattern or insight, the machine learning algorithm or artificial intelligence may be trained to determine that no fraud-related pattern or insight can be derived from the sample data.

In an embodiment, through the machine learning algorithm or artificial intelligence, the data enhancement system 210 may perform such clustering or classification of different data as this data is received from the different data sources. Through this processing of the different data from these different data sources, the data enhancement system 210 may obtain partial matches among different known fraud-related patterns and/or insights to detect any fraud-related patterns and/or insights corresponding to the obtained data and that may be used to process obtained transaction data. Further, if evaluation of embeddings of a particular data fails to satisfy the aforementioned threshold for identification of a fraud-related pattern and/or insight that may be used to detect fraudulent transactions, the machine learning algorithm or artificial intelligence may automatically process transaction data according to other known fraud-related patterns and insights. As the data enhancement system 210 generates fraud-related patterns and insights, the data enhancement system 210 may provide these fraud-related patterns and insights to the query orchestration system 202, which may provide these to the payment instrument authorization service 104.

It should be noted that while the transactional fraud platform 102 is illustrated in FIG. 2 as including four distinct transaction analysis systems 204-210, the transactional fraud platform 102 may implement additional and/or alternative transaction analysis systems to provide additional functionalities for fraud detection and for providing additional security layers for accounts associated with the payment instrument authorization service 104. For example, as noted above, the transactional fraud platform 102 may implement a dynamic verification value evaluation microservice that is configured to automatically, and in real-time or near real-time, evaluate any transaction data submitted by different merchant systems 106 as the transaction data is received to determine whether any included dynamic verification values are valid. These dynamic verification values may be generated according to a secret code shared between the payment instrument service and a payment instrument service application implemented on a user device. The secret code may be a statistically unique identifier that may serve as a verification value seed for the generation of dynamic verification values. Alternatively, in some instances, the secret code may be a shared secret established between the payment instrument service application and the payment instrument service, which implements the transactional fraud platform 102. The dynamic verification value evaluation microservice may evaluate transaction data corresponding to a transaction to determine whether a provided CVV (a dynamic verification value or static verification value) corresponds to the specified account. Based on this evaluation, the dynamic verification value evaluation microservice may generate different fraud-related patterns and/or insights corresponding to different transactions, as described in greater detail herein.

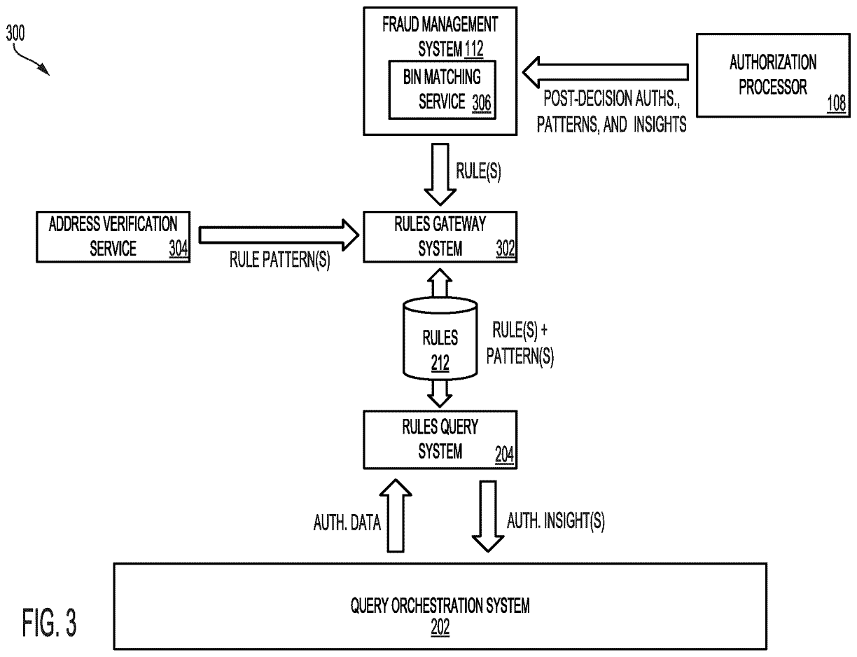

FIG. 3 shows an illustrative example of an environment 300 in which a rules query system 204 implemented through a transactional fraud platform dynamically evaluates transaction data according to address verification and BIN matching rules to identify fraud-related patterns and insights in accordance with at least one embodiment. In the environment 300, the rules query system 204 obtains, from the query orchestration system 202, transaction data corresponding to different transactions that are pending authorization for settlement. As noted above, the rules query system 204 further obtains a set of rules and rule patterns from other services and systems and that may be used to evaluate transaction data and accordingly identify different fraud-related patterns and insights that may be used to enrich any pending transactions and that may be processed by an authorization processor 108 to generate authorization and settlement determinations. In an embodiment, the rules query system 204 obtains this set of rules and rules patterns through a rules datastore 212 implemented by the transactional fraud platform. As noted above, the rules datastore 212 may dynamically store any applicable rule patterns and rules provided by different entities (as described herein) that may be used to evaluate transaction data provided by the query orchestration system 202. These rule patterns and rules may be obtained by a rules gateway system 302, which may dynamically store these rule patterns and rules in the rules datastore 212 as the rule patterns and rules are obtained.

In an embodiment, the rules gateway system 302 obtains, through one or more APIs implemented by the transactional fraud platform, a set of rule patterns generated by an address verification service 304. As noted above, the address verification service 304 may be implemented by the transactional fraud platform 102 or other entity associated with the transactional fraud platform 102 (e.g., a payment instrument service, etc.) to perform ongoing evaluations of transactions for which addresses associated with different user accounts are available and, based on these evaluations, generate new rule patterns corresponding to different addresses. The address verification service 304, in an embodiment, processes transaction data from the payment instrument authorization service to extract, from each transaction, an address, an account number (i.e., a PAN), and a client timestamp (i.e., the time at which the transaction was initiated). For a given transaction, the address verification service 304 may attempt to insert the indicated address into a first table, where the indicated address may serve as a primary key. If the address is not present within the first table, the address verification service 304 may insert this address into the first table, as the address may be a new address not previously encountered by the address verification service 304. However, if the address is already present within the first table, the address verification service 304 may trigger an RDBMS exception.

As noted above, if an address RDBMS exception is triggered, the address verification service 304 may attempt to insert the address and the associated account number provided in the corresponding transaction into a second table. This combination of the address and associated account number may serve as a primary key for the second table. If the address verification service 304 determines that the primary key corresponding to the combination of the address and associated account number can be inserted into this second table, the address verification service 304 may add this primary key to the second table as this primary key may represent a new combination of address and account number. Further, within the entry corresponding to this primary key in the second table, the address verification service may incorporate a timestamp corresponding to when the transaction including this address and account number was initiated.

If the address verification service 304 determines that the primary key is present within the second table, the address verification service 304 may increment a counter that corresponds to the number of times that the combination of address and account number has been encountered over a pre-defined threshold period of time (e.g., a one-hour period, a two-hour period, etc.) from the timestamp indicated in the entry. As insertion of the primary key into the second table may denote a second occurrence of the address identified by the address verification service, a counter threshold for determining RDBMS exceptions for the second table may be tailored to be one less than the desired address reoccurrence threshold. The counter threshold may be defined according to a pre-defined temporal window (e.g., a one-hour window, a two-hour window, etc.) whereby if the counter corresponding to a particular address/account number combination reaches this counter threshold within the pre-defined temporal window, the address verification service 304 may automatically generate a rule pattern that denotes the existence of potential fraud associated with the address. The rule pattern may incorporate a temporal rule whereby any transactions including the identified address received within a temporal window (e.g., a one-hour window, a two-hour window, etc.) starting from the time of the transaction that triggered the RDBMS exception within the second table are to be automatically rejected. Additionally, the address verification service 304 may update the timestamp of the record within the second table to enforce the pre-defined temporal window.

If the counter threshold is reached for a particular address/account number combination, the address verification service 304 may transmit this rule pattern to the rules gateway system 302, which may store the newly generated rule pattern in the rules datastore 212. In an embodiment, when the rules gateway system 302 stores this rule pattern in the rules datastore 212, the rules query system 204 may automatically detect this new rule pattern and query the rules datastore 212 to obtain the new rule pattern. In response to receiving the rule pattern, the rules query system 204 may implement this rule pattern to automatically identify any fraud-related patterns and insights that may be applied to transactions that include the specified address within the transaction data obtained from the query orchestration system 202. The address verification service 304 may update the timestamp within the entry corresponding to the address/account number combination to enforce this newly generated rule pattern. At the conclusion of the time window for the rule pattern, the address verification service 304 may remove the entries corresponding to the address within the tables implemented by the address verification service. Further, the rules query system 204 may automatically remove the rule pattern and continue processing new transaction data without applying the now-expired rule pattern.

As noted above, the rules query system 204 may further process any applicable BIN matching rules to obtained transaction data to identify additional fraud-related patterns and insights. In an embodiment, the rules query system 204 obtains these BIN matching rules from the rules datastore 212. For instance, the BIN matching rules may be generated by a BIN matching service 306 through the rules gateway system 302. The BIN matching rules may be generated by the BIN matching service 306 implemented by a fraud management system 112 or by an authorization processor 108 based on ongoing evaluations of transactions for which account numbers (e.g., PANs) are provided and that include corresponding BINs. As noted above, a transaction may include an account number, such as a PAN, corresponding to an account maintained by a payment instrument service for a particular account holder. The account number may be defined using a string of alphanumeric characters, whereby a subset of alphanumeric characters may include the BIN associated with the payment instrument service that maintains the account.

In some instances, and as illustrated in FIG. 3, the BIN matching service 306 may obtain post-authorization data from the authorization processor 108 and, accordingly, process this post-authorization data to generate a set of BIN matching rules. The post-authorization data may indicate, for each transaction processed by the authorization processor 108, whether the transaction was authorized and settled. Further, for each transaction, the post-authorization data may include a PAN associated with the payment instrument used for the transaction, an expiration date for the payment instrument, a card verification value (CVV) associated with the payment instrument, the payment amount associated with the transaction, merchant information, and the like. The BIN matching service 306 may process the post-authorization data from the authorization processor 108 (such as through a trained machine learning algorithm or artificial intelligence) to detect any attempts at BIN hacking or other BIN-related attacks. If the BIN matching service 306 identifies any BIN hacking or other BIN-related attacks associated with a particular BIN, the BIN matching service 306 may define one or more rules corresponding to the particular BIN and that may be used to flag or otherwise evaluate transactions associated with the particular BIN prior to these transactions being provided to the authorization processor 108 for authorization and settlement.

As an illustrative example of this rule-making process, the BIN matching service 306 or the authorization processor 108 may define BIN matching rules based on the frequency of transactions including the same BIN, which may denote attempts at BIN hacking or other BIN-related attacks. For instance, as noted above, a malicious actor may utilize brute-force methods to identify a valid combination of a PAN, an expiration date for the account, and a card verification value (CVV). When a valid combination is found, the malicious actor may try new combinations that rely on the BIN identified from the identified valid combination. To identify a valid combination, a malicious actor may attempt numerous transactions using different combinations of PANs, expiration dates, and CVVs until a combination is identified for which corresponding transactions are authorized by the authorization processor 108.

In some instances, the authorization processor 108 and/or the BIN matching service 306 may evaluate the post-authorization data corresponding to different transactions to identify any BIN-related patterns that may denote the occurrence of BIN hacking or other BIN-related attack for particular BINs. For instance, if a threshold number of transactions over a pre-defined period of time is rejected for not being associated with a valid account, the authorization processor 108 and/or BIN matching service may determine whether these transactions have reoccurring BINs associated with them. If so, the authorization processor 108 and/or the BIN matching service 306 may define a rule whereby any transactions associated with account numbers having the identified BIN should be subject to greater scrutiny or outright rejected for a period of time.

As the authorization processor 108 and/or the BIN matching service 306 generate new BIN-specific rules, the authorization processor 108 and/or the BIN matching service 306 may automatically transmit these BIN-specific rules to the rules gateway system 302, which may store these new BIN-specific rules in the rules datastore 212. In some instances, the rules query system 204 may query the rules datastore 212 to identify any newly generated BIN-specific rules that may be applicable to transactions being processed through the transactional fraud platform. The rules query system 204 may process any obtained transaction data according to these new BIN-specific rules to identify any new fraud-related patterns and insights that may be used to enrich these transactions, which may allow the authorization processor 108 to make more accurate authorization and settlement determinations.

As noted above, in some instances, the rules query system 204 may implement a machine learning algorithm or artificial intelligence that is trained to identify fraud-related patterns and insights based on its evaluation of different transactions according to applicable rules and rule patterns. The machine learning algorithm or artificial intelligence implemented by the rules query system 204 may be trained using a dataset of sample transaction data, sample rules and rule patterns, and sample (known or expected) patterns and insights. The machine learning algorithm or artificial intelligence may be initialized with a first set of values corresponding to different hyperparameters or other coefficients that, in combination, are used to derive an output given a sample input (e.g., sample transaction data and corresponding sample rules and rule patterns). Using this initial iteration of the machine learning algorithm or artificial intelligence, the rules query system 204 may process the dataset of sample transaction data and sample rules and rule patterns to identify fraud-related patterns and insights. The machine learning algorithm or artificial intelligence may compare the output (e.g., predicted fraud-related patterns and insights) to the expected fraud-related patterns and insights included in the dataset. Based on this comparison, the machine learning algorithm or artificial intelligence may dynamically update the values corresponding to the different hyperparameters or other coefficients and again process the dataset to generate new outputs. This process may be repeated numerous times until an iteration of the machine learning algorithm or artificial intelligence is obtained that satisfies one or more accuracy or predictability thresholds.

As the rules query system 204 generates, based on the obtained transaction data and applicable rules and rule patterns, fraud-related patterns and insights, the rules query system 204 may transmit these fraud-related patterns and insights to the query orchestration system 202. As noted above, the query orchestration system 202 may provide the fraud-related patterns and insights to the payment instrument authorization service, which may enrich corresponding transactions with these fraud-related patterns and insights. The authorization processor 108, in response to receiving these enriched transactions, may evaluate these transactions according to its own heuristics and the provided fraud-related patterns and insights to determine whether to authorize and settle these transactions.

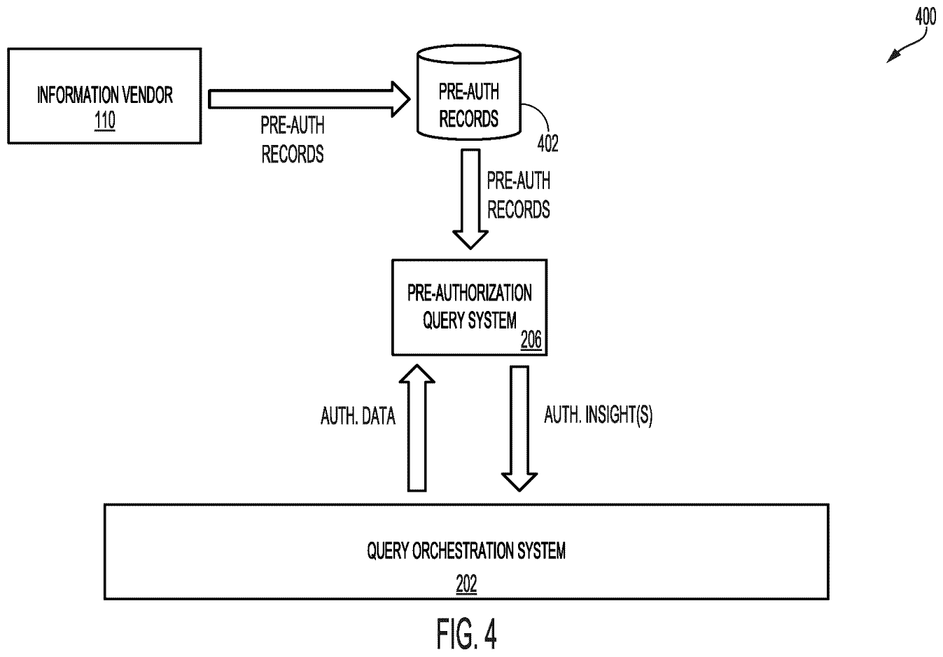

FIG. 4 shows an illustrative example of an environment 400 in which a pre-authorization query system 206 implemented through a transactional fraud platform compares pre-authorization records and transaction data corresponding to different transactions to identify fraud-related patterns and insights in accordance with at least one embodiment. In the environment 400, the pre-authorization query system 206 obtains, from the query orchestration system 202, transaction data corresponding to different transactions that are pending authorization. As noted above, the pre-authorization query system 206 is implemented to dynamically evaluate pre-authorization transaction records from one or more information vendors 110 to identify any transaction patterns and insights that may be used to generate preliminary transaction authorization decisions as transaction data is obtained from the query orchestration system 202.

In an embodiment, the pre-authorization query system 206 obtains, through one or more APIs implemented by the transactional fraud platform through a pre-authorization transaction records database 402, pre-authorization records generated by an information vendor 110 prior to merchant systems transmitting transaction data to the payment instrument authorization service for authorization and settlement. For instance, prior to transmitting transaction data for a particular transaction to the payment instrument authorization service for authorization and settlement, a merchant system may transmit this transaction data corresponding to the particular transaction to an information vendor 110 for initial evaluation. As noted above, the information vendor 110 may be a service that contracts with a merchant to analyze transactions in real-time to determine whether these transactions may be submitted for authorization and settlement to the payment instrument authorization service or authorization processor. The information vendor 110 may utilize machine learning algorithms and/or artificial intelligence to evaluate new transactions and determine whether these transactions may be approved for authorization or should be rejected.

In an embodiment, as the information vendor 110 generates pre-authorization transaction records corresponding to different transactions initiated through one or more merchant systems, the pre-authorization transaction records may be stored within the pre-authorization transaction records database 402 implemented by the transactional fraud platform. The pre-authorization transaction records database 402 may be implemented through a MySQL or other relational database management system (RDBMS) for storage of these pre-authorization transaction records as these are received from the information vendor 110. A pre-authorization transaction record within the pre-authorization transaction records database 402 may be keyed according to a timestamp corresponding to the time at which the transaction was initiated by a merchant system. Further, a pre-authorization transaction record within the pre-authorization transaction records database 402 may denote a transaction amount, account information corresponding to the payment instrument used for the transaction, contact information associated with the user, merchant information, session identifier corresponding to the transaction, and the device identifier corresponding to the user device (if the transaction was initiated through a user device). The pre-authorization transaction record for a particular transaction may further denote whether the transaction was approved or rejected by the information vendor 110.

In an embodiment, the pre-authorization query system 206 evaluates the pre-authorization transaction records from the pre-authorization transaction records database 402, periodically or as these records are received, to identify any fraud-related patterns and/or insights associated with these pre-authorization transaction records and corresponding approval/rejection decisions generated by the information vendor 110. In some instances, the pre-authorization transaction records may be used by the pre-authorization query system 206 to detect any fraud-related patterns and insights without regard to the approval/rejection decisions generated by the information vendor 110. This may allow the pre-authorization query system 206 to independently detect potential fraud associated with these transactions prior to the transaction data being provided by the payment instrument authorization service through the query orchestration system 202.

When the pre-authorization query system 206 receives, from the query orchestration system 202, transaction data corresponding to different transactions pending authorization and settlement, the pre-authorization query system 206 may review the transaction data to determine whether the transaction data corresponds to any transactions previously evaluated by the information vendor 110 and specified in the pre-authorization transaction records. For example, in response to receiving this transaction data, the pre-authorization query system 206 may query the pre-authorization transaction records database 402 to identify any transaction records corresponding to transactions previously processed by information vendor 110 and that match the transactions specified in the obtained transaction data. The query to the pre-authorization transaction records database 402 may include, for instance, one or more characteristics associated with a PAN corresponding to a payment instrument used for a transaction (e.g., a set of digits corresponding to the PAN, etc.), the transaction amount corresponding to the transaction, and a time range centered around the time at which the transaction data was received (e.g., five seconds, ten seconds, etc.). Based on this query, the pre-authorization query system 206 may identify any pre-authorization transaction records that match the transactions specified in the transaction data.

If the pre-authorization query system 206 determines that the transaction data corresponding to a particular payment instrument and transaction matches a preliminary transaction record corresponding to a transaction previously processed by the information vendor 110, the pre-authorization query system 206 may return, to the payment instrument authorization service and through the query orchestration system 202, any previously identified fraud-related patterns and insights corresponding to the payment instrument and the transaction. Alternatively, if the pre-authorization query system 206 determines that the transaction data does not correspond to any previously obtained pre-authorization transaction records, the pre-authorization query system 206 may forego providing any fraud-related patterns or insights, as none have been created for the payment instrument. In some instances, the pre-authorization query system 206, through the query orchestration system 202, may return an indication that no fraud-related patterns or insights were identified for the payment instrument and the corresponding transaction.

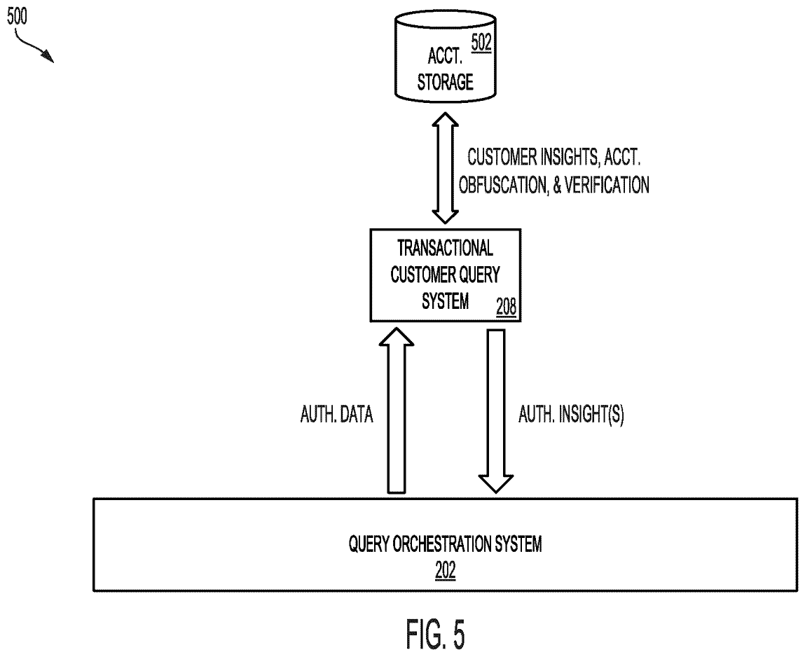

FIG. 5 shows an illustrative example of an environment 500 in which a transactional customer query system 208 implemented through a transactional fraud platform converts plaintext account numbers into obfuscated account numbers for verification of existing accounts in accordance with at least one embodiment. In the environment 500, the transactional customer query system 208 obtains transaction data corresponding to different transactions from the query orchestration system 202. The transactional customer query system 208, as noted above, may automatically process the plaintext account number associated with the new payment instrument through a custom obfuscation processor to generate an obfuscated account number that may be stored by the transactional fraud platform within an account storage repository 502. Thus, only the obfuscated account numbers for different payment instrument accounts may be used to access payment instrument accounts through the account storage repository 502.

In an embodiment, when the transactional customer query system 208 receives transaction data from the query orchestration system 202, the transactional customer query system 208 extracts the plaintext account numbers associated with the payment instruments used in the corresponding transactions. The transactional customer query system 208 may encrypt or tokenize these plaintext account numbers to obtain corresponding obfuscated account numbers that may be evaluated to determine whether these obfuscated account numbers correspond to existing accounts maintained by the payment instrument service. The transactional customer query system 208 may query the account storage repository 502 using these obfuscated account numbers to determine whether the obfuscated account numbers correspond to active payment instrument accounts maintained by the payment instrument service. For instance, if an obfuscated account number generated by the transactional customer query system 208 does not correspond to an existing account within the account storage repository 502, the transactional customer query system 208 may transmit, to the query orchestration system 202, an indication that there are no patterns or insights associated with the obfuscated account numbers. Accordingly, the query orchestration system 202 may transmit this indication to the payment instrument authorization service, which may proceed to perform any actions related to a failure to identify existing accounts associated with the one or more obfuscated account numbers.

For any valid accounts identified by the transactional customer query system 208, the transactional customer query system 208 may evaluate these valid accounts associated with the pending transactions to identify any usage patterns. As noted above, the transactional customer query system 208 may evaluate any identified active accounts to determine whether these active accounts are subject to any fraud-related alerts or other actions. For any accounts that are subject to a fraud-related alert or other action, the transactional customer query system 208 may evaluate these active accounts through one or more machine learning algorithm or artificial intelligence processes to identify any common account and/or transaction characteristics that may be used to derive any fraud-related patterns or insights that may be used to enrich the corresponding transactions and other transactions that may share these common account and/or transaction characteristics. For instance, if the transactional customer query system 208, through processing of transactions and corresponding payment instrument accounts through the trained machine learning algorithm or artificial intelligence identifies payment instruments for which multiple invalid PANs are being provided over a short period of time, the transactional customer query system 208 may determine that valid payment instruments sharing certain characteristics with these invalid PANs may be the target of possible brute force attempts to access the payment instrument accounts associated with these payment instruments. This fraud-related insight may allow for real-time generation of authorization decisions for transactions having the identified account characteristics.

The transactional customer query system 208, through the query orchestration system 202 may provide any newly generated account usage and fraud-related patterns and insights to the payment instrument authorization service. As noted above, the query orchestration system 202 may provide these account usage and fraud-related patterns and insights to the payment instrument authorization service, which may use these patterns and insights to define policies for automatically enriching transactions associated with different payment instruments as new transaction data is received. These enriched transactions may be used by the authorization processor to make authorization and settlement determinations, as well as detect any fraudulent activity associated with these transactions.

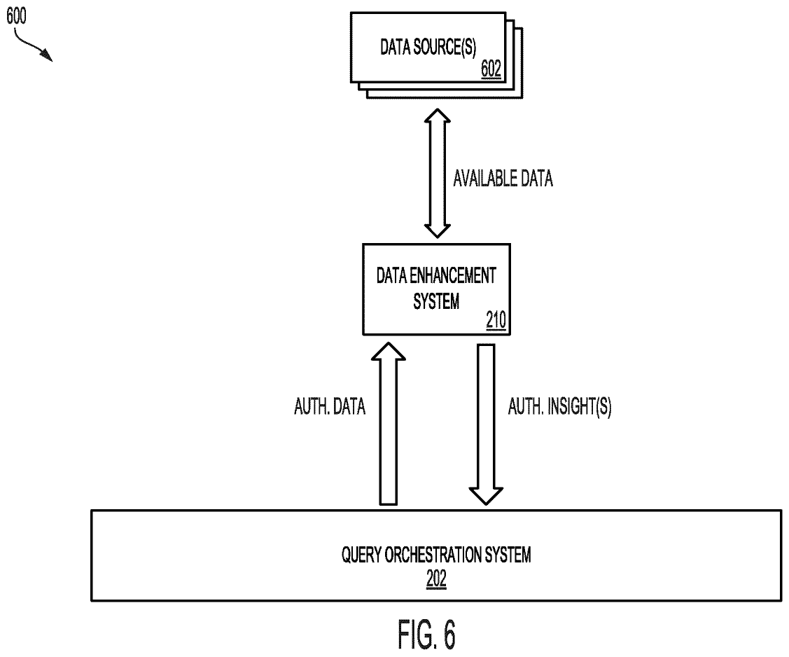

FIG. 6 shows an illustrative example of an environment 600 in which a data enhancement system 210 implemented through a transactional fraud platform queries one or more data sources 602 for fraud-related data and processes the fraud-related data to identify fraud-related patterns and insights in accordance with at least one embodiment. In the environment 600, the data enhancement system 210 queries one or more data sources 602 to obtain fraud-related data that may be used to identify any fraud-related patterns and insights usable by an authorization processor to make transaction authorization decisions. The one or more data sources 602 may include credit bureaus, credit reporting agencies, government agencies, and/or other fraud monitoring agencies that may monitor and report any fraud-related incidents to different entities and/or the general public. In some instances, the one or more data sources 602 may further include merchants, retailers, or other entities that may be engaged in consumer transactions and that may detect fraudulent activity. The one or more data sources 602 may further include data repositories and other systems maintained by the payment instrument authorization service and/or the transactional fraud platform. For example, the payment instrument authorization service and/or the transactional fraud platform may maintain data corresponding to fraud-related incidents detected by the payment instrument authorization service and/or the transactional fraud platform based on user communications, actions taken in response to detecting fraudulent activity, and the like.

In an embodiment, the data enhancement system 210 implements a machine learning algorithm or artificial intelligence that is trained to identify any fraud-related patterns or insights from any data obtained from the data sources 602. The machine learning algorithm or artificial intelligence may be trained using a dataset of sample fraud-related data (e.g., historical and/or hypothetical press releases, fraud alerts and notifications, credit reports, etc.) and sample fraud-related patterns and insights corresponding to the sample fraud-related data (e.g., historical fraud-related patterns and insights, hypothetical fraud-related patterns and insights, combinations of historical and hypothetical fraud-related patterns and insights, etc.). This dataset may be analyzed by the machine learning algorithm or artificial intelligence by converting the sample fraud-related data into a set of data embeddings and the sample fraud-related patterns and insights into a set of fraud-related embeddings. The machine learning algorithm or artificial intelligence may classify the sample fraud-related data according to one or more vectors of similarity between the set of data embeddings and the set of fraud-related embeddings. In some instances, the machine learning algorithm or artificial intelligence may be implemented with a threshold that may be used to determine, based on the aforementioned embeddings and the one or more vectors of similarity, whether sample fraud-related data is sufficiently similar (e.g., satisfies the threshold by having a requisite amount of embeddings being within a level of tolerance of corresponding fraud-related embeddings for a particular known pattern and/or insight) to a particular sample fraud-related pattern and/or insight. If a sample fraud-related data does not satisfy the required threshold for classification to a particular known fraud-related pattern or insight, the machine learning algorithm or artificial intelligence may be trained to determine that no fraud-related pattern or insight can be derived from the sample fraud-related data.

In an embodiment, through the machine learning algorithm or artificial intelligence, the data enhancement system 210 may perform such clustering or classification of different fraud-related data as this fraud-related data is received from the different data sources 602. Through this processing of the different fraud-related data, the data enhancement system 210 may obtain partial matches among different known fraud-related patterns and/or insights to detect any fraud-related patterns and/or insights corresponding to the obtained fraud-related data and that may be used to process obtained transaction data. Further, if evaluation of embeddings of a particular fraud-related data point fails to satisfy the aforementioned threshold for identification of a fraud-related pattern and/or insight that may be used to detect fraudulent transactions, the machine learning algorithm or artificial intelligence may automatically process transaction data according to other known fraud-related patterns and insights. As the data enhancement system 210 generates fraud-related patterns and insights, the data enhancement system 210 may provide these fraud-related patterns and insights to the query orchestration system 202, which may provide these to the payment instrument authorization service.

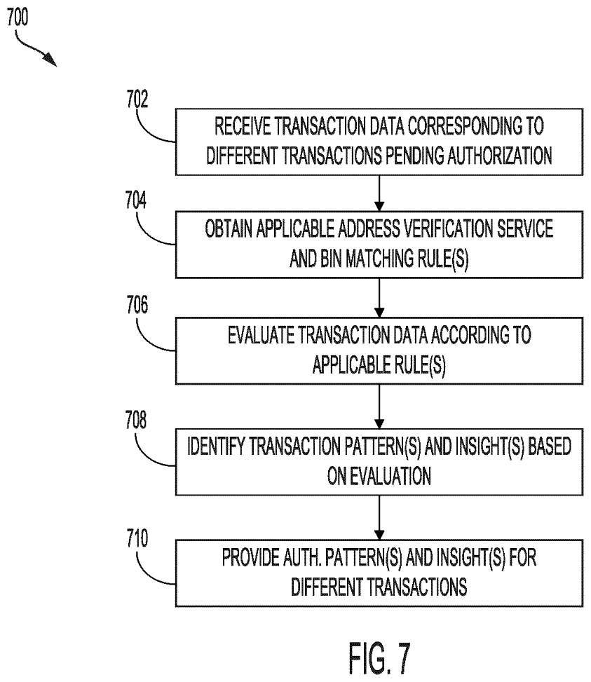

FIG. 7 shows an illustrative example of a process 700 for evaluating transaction data according to applicable address verification and BIN matching rules to generate fraud-related insights in accordance with at least one embodiment. The process 700 may be performed by a rules query system implemented through a transactional fraud platform.

At step 702, the rules query system may receive transaction data corresponding to different transactions that are pending authorization. As noted above, a payment instrument authorization service may query a set of transaction analysis systems (including the rules query system) implemented by the transactional fraud platform in parallel to obtain different fraud-related patterns and insights that may be used to enrich different transactions pending authorization to allow an authorization processor to make authorization and settlement decisions based on these enriched transactions. To query the rules query system for different transaction classifications, the payment instrument authorization service may transmit the obtained transaction data to a query orchestration system implemented by the transactional fraud platform. The query orchestration system may automatically transmit the obtained transaction data to the rules query system to allow the rules query system to evaluate the transaction data.

At step 704, the rules query system may obtain address verification service rules and BIN matching rules that may be implemented to evaluate the obtained transaction data. As noted above, the rules query system may obtain these rules through a rules datastore implemented by the transactional fraud platform and through which these rules may be stored by a rules gateway system. For instance, the rules gateway system may obtain, through one or more APIs implemented by the transactional fraud platform, a set of rule patterns generated by an address verification service. These rule patterns may denote the existence of potential fraud associated with one or more addresses, as determined by the address verification service through evaluation of provided transaction data over time. A rule pattern may incorporate a temporal rule whereby any transactions including the identified address received within a temporal window (e.g., a one-hour window, a two-hour window, etc.) starting from the time of the transaction that triggered creation of the rule are to be automatically rejected. In addition to these address-specific rule patterns, the rules query system may obtain, through the rules datastore, a set of BIN matching rules generated by a BIN matching service associated with a fraud management system. This set of BIN matching rules may be defined by the BIN matching service based on the frequency of transactions including the same BIN, which may denote attempts at BIN hacking or other BIN-related attacks.

At step 706, the rules query system may evaluate the obtained transaction data according to any applicable address-related rule patterns and BIN matching rules to identify, at step 708, identify any fraud-related patterns and/or insights that may be used to automatically enrich these transactions and allow the authorization processor to identify potentially fraudulent transactions. As noted above, in some instances, the rules query system may implement a machine learning algorithm or artificial intelligence that is trained to generate fraud-related insights based on its evaluation of different transactions according to applicable rules and rule patterns. Accordingly, the rules query system may process the various transactions and the obtained rules and rule patterns through the trained machine learning algorithm or artificial intelligence to identify these fraud-related patterns and/or insights.

At step 710, as the rules query system generates, based on the obtained transaction data and applicable rules and rule patterns, fraud-related patterns/insights, the rules query system may transmit fraud-related patterns and insights to the query orchestration system. As noted above, the query orchestration system may provide the fraud-related insights to the payment instrument authorization service, whereby the payment instrument authorization service may use the provided fraud-related patterns and insights to enrich the pending transactions (e.g., incorporate the identified fraud-related patterns and insights by updating one or more data fields associated with the pending transactions to include values corresponding to the identified fraud-related patterns and insights, as applicable).

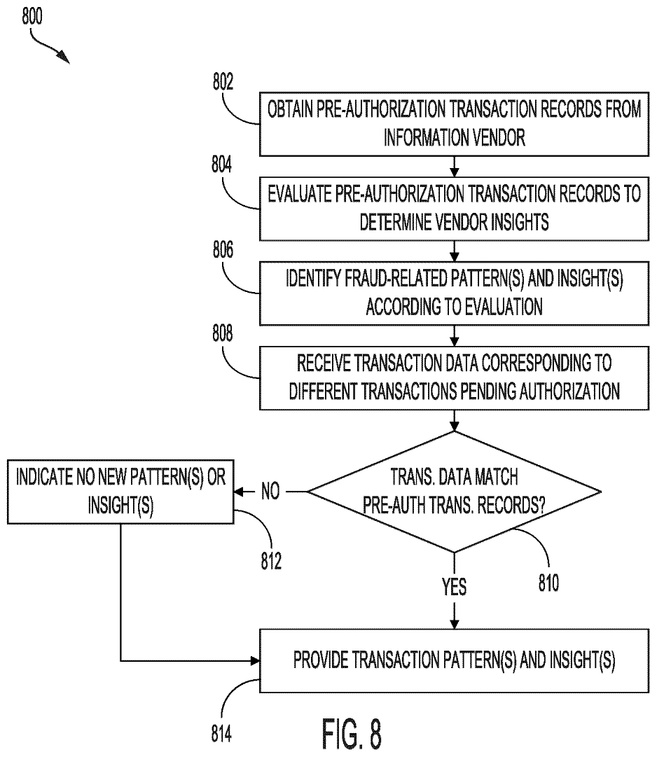

FIG. 8 shows an illustrative example of a process 800 for comparing pre-authorization records to transaction data corresponding to different transactions to generate fraud-related insights in accordance with at least one embodiment. The process 800 may be performed by a pre-authorization query system implemented through a transactional fraud platform.

At step 802, the pre-authorization query system, through one or more APIs, may obtain a set of pre-authorization transaction records from one or more information vendors. As noted above, prior to transmitting transaction data for a particular transaction to the payment instrument authorization service for authorization and settlement, a merchant system may transmit this transaction data corresponding to the particular transaction to an information vendor for initial evaluation. The information vendor may analyze the transaction in real-time to determine whether the transaction may be submitted for authorization and settlement to the payment instrument authorization service or to an authorization processor. The pre-authorization transaction records obtained by the pre-authorization query system through the one or more APIs may include transaction data corresponding to ongoing transactions evaluated by the information vendor, as well as any approval/rejection decisions generated by the information vendor based on its evaluation of these ongoing transactions through its own heuristics, machine learning/artificial intelligence systems, or other techniques.

At step 804, the pre-authorization query system may evaluate the pre-authorization transaction records from the one or more information vendors to determine the authorization decisions generated by the information vendor. For instance, the pre-authorization query system may process each pre-authorization transaction record to determine whether the corresponding transaction was approved or rejected by the information vendor. Further, the pre-authorization query system may determine whether the pre-authorization transaction record provides an indication as to the rationale for approving or rejecting the corresponding transaction. For instance, a pre-authorization transaction record may include a code or other identifier corresponding to an approval or rejection rationale generated by the information vendor for the transaction. The pre-authorization query system may store these pre-authorization transaction records and corresponding approval/rejection decisions for evaluation of any transaction data obtained from the payment instrument authorization service.

At step 806, the pre-authorization query system may identify any fraud-related patterns and/or insights according to the evaluation of the pre-authorization transaction records. For instance, the pre-authorization query system may process the obtained pre-authorization transaction records through a trained machine learning algorithm or artificial intelligence to perform an initial analysis of the transaction data included in the pre-authorization transaction records and identify fraud-related patterns and/or insights associated with these transactions. Returning to an earlier illustrative example, if the pre-authorization query system, through processing of pre-authorization transaction records through the trained machine learning algorithm or artificial intelligence, identifies payment instruments for which multiple CVVs, expiration dates, and the like are being provided over a short period of time, the pre-authorization query system may determine that these payment instruments may be the target of possible brute force attempts to access the accounts associated with these payment instruments. This fraud-related insight may allow the pre-authorization query system to automatically enrich transaction data being provided by the payment instrument authorization service through the query orchestration system. In some instances, the pre-authorization transaction records may be used by the pre-authorization query system to detect any fraud-related patterns and insights without regard to the approval/rejection decisions generated by the information vendor. This may allow the pre-authorization query system to independently detect potential fraud associated with these transactions prior to the transaction data being provided by the payment instrument authorization service through the query orchestration system.

At step 808, the pre-authorization query system may receive transaction data corresponding to different transactions pending authorization and settlement. As noted above, a payment instrument authorization service may query a set of transaction analysis systems (including the pre-authorization query system) implemented by the transactional fraud platform in parallel to identify any fraud-related patterns and/or insights that may be used to enrich this transaction data prior to providing the transaction data to the authorization processor for authorization and settlement. To query the pre-authorization query system for different transaction classifications, the payment instrument authorization service may transmit the obtained transaction data to a query orchestration system implemented by the transactional fraud platform. The query orchestration system may automatically transmit the obtained transaction data to the pre-authorization query system to allow the pre-authorization query system to evaluate the transaction data.

At step 810, the pre-authorization query system may compare the transaction data to the previously received pre-authorization transaction records to determine whether the transaction data corresponds to any transactions previously processed by the information vendor, as indicated in the pre-authorization transaction records. For example, the pre-authorization query system may compare the PAN associated with the payment instrument used for a given transaction (as indicated in the transaction data) to the different PANs indicated in the pre-authorization transaction records to determine whether the PAN corresponds to any transactions previously evaluated by the information vendor. Further, for any identified pre-authorization transactions corresponding to the PAN, the pre-authorization query system may determine whether the transaction amount indicated in the transaction data matches the transaction amount of any of the pre-authorization transactions. If so, the pre-authorization query system may determine whether any matching transactions occurred within a pre-defined period of time (e.g., within five seconds, ten seconds, etc.) from an authorization determination generated by the information vendor and indicated in the pre-authorization transaction records. Based on these evaluations, the pre-authorization query system may identify any matching transactions for which the pre-authorization query system has identified any relevant fraud-related patterns and/or insights.

If the pre-authorization query system determines that the obtained transaction data does not correspond to any transactions previously processed by the information vendor, the pre-authorization query system, at step 812, may return an indication, to the query orchestration system, that there are no identified patterns or insights related to the transactions specified in the transaction data. However, if the pre-authorization query system determines that the obtained transaction data corresponding to a particular transaction matches a transaction previously evaluated by the information vendor and for which the pre-authorization query system has identified one or more fraud-related patterns and/or insights, the pre-authorization query system, at step 814, may provide these one or more fraud-related patterns and/or insights to the payment instrument authorization service through the query orchestration system.

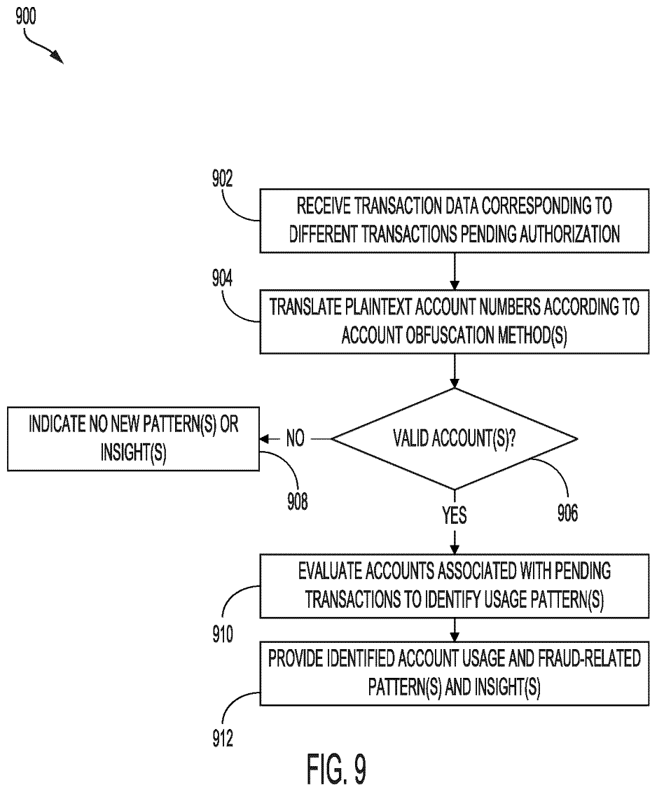

FIG. 9 shows an illustrative example of a process 900 for translating plaintext account identifiers according to account obfuscation methods to determine the validity of different accounts associated with different transactions in accordance with at least one embodiment. The process 1000 may be performed by a transactional customer query system implemented through a transactional fraud platform.

At step 902, the transactional customer query system may receive transaction data corresponding to different transactions that are pending authorization. As noted above, a payment instrument authorization service may query a set of transaction analysis systems (including the account obfuscation query system) implemented by the transactional fraud platform in parallel to identify different fraud-related patterns and insights that may be used to enrich different transactions that are to be processed by an authorization processor for authorization and settlement. To query the transactional customer query system for identification of fraud-related patterns and insights, the payment instrument authorization service may transmit the obtained transaction data to a query orchestration system implemented by the transactional fraud platform. The query orchestration system may automatically transmit the obtained transaction data to the transactional customer query system to allow the transactional customer query system to evaluate the transaction data.

At step 904, the transactional customer query system may translate the plaintext account numbers that correspond to the payment instruments used for the pending transactions into obfuscated account numbers according to applicable account obfuscation methods. As noted above, the transaction data transmitted by a merchant system and corresponding to a particular transaction may specify account information corresponding to the payment instrument used for the transaction, including the PAN associated with the payment instrument in plaintext form. When the transactional customer query system receives transaction data from the query orchestration system, the transactional account query system extracts the plaintext PANs associated with the payment instruments used in the corresponding transactions. The transactional account query system may encrypt or tokenize these plaintext PANs to obtain corresponding obfuscated account numbers that may be evaluated to determine whether these obfuscated account numbers correspond to existing accounts maintained by the payment instrument service.

At step 906, the transactional customer query system may determine, for each transaction, whether the corresponding obfuscated account number corresponding to an active and valid account. As noted above, the payment instrument service that implements the transactional fraud platform may further implement an account storage repository that dynamically stores obfuscated account numbers corresponding to different payment instrument accounts maintained by the payment instrument service. When a new payment instrument is issued to a user, the transactional customer query system or other system implemented by the payment instrument service may process the plaintext account number (e.g., PAN) associated with the new payment instrument through a custom obfuscation processor to generate an obfuscated account number that may be stored by the payment instrument service within the account storage repository. Similarly, when the transactional customer query system receives transaction data from the query orchestration system, the transactional customer query system may encrypt or tokenize these plaintext account numbers to obtain corresponding obfuscated account numbers that may be evaluated to determine whether these obfuscated account numbers correspond to existing accounts maintained by the payment instrument service. The transactional customer query system may query the account storage repository using these obfuscated account numbers to determine whether the obfuscated account numbers correspond to active payment instrument accounts maintained by the payment instrument service.

If the transactional customer query system determines that one or more obfuscated account numbers do not correspond to existing accounts within the account storage repository, the transactional customer query system, at step 908, may transmit an indication that there are no patterns or insights associated with the obfuscated account numbers. Accordingly, the payment instrument authorization service may proceed to perform any actions related to a failure to identify existing accounts associated with the one or more obfuscated account numbers.

For any valid accounts identified by the transactional customer query system, the transactional customer query system may evaluate, at step 910, these valid accounts associated with the pending transactions to identify any usage patterns. As noted above, the transactional customer query system may evaluate any identified active accounts to determine whether these active accounts are subject to any fraud-related alerts or other actions (e.g., an account is frozen on account of detected fraudulent activity, etc.). For any accounts that are subject to a fraud-related alert or other action, the transactional customer query system may evaluate these active accounts through one or more machine learning algorithm or artificial intelligence processes to identify any common account and/or transaction characteristics that may be used to derive any fraud-related patterns or insights that may be used to enrich the corresponding transactions and other transactions that may share these common account and/or transaction characteristics. For instance, if the transactional customer query system, through processing of transactions and corresponding payment instrument accounts through the trained machine learning algorithm or artificial intelligence identifies payment instruments for which multiple invalid PANs are being provided over a short period of time, the transactional customer query system may determine that valid payment instruments sharing certain characteristics with these invalid PANs (e.g., similar BINs, associated with the same private label, etc.) may be the target of possible brute force attempts to access the payment instrument accounts associated with these payment instruments. This fraud-related insight may allow for real-time generation of authorization decisions for transactions having the identified account characteristics.

At step 914, the transactional customer query system may provide the newly generated account usage and fraud-related patterns and insights to the payment instrument authorization service through the query orchestration system of the transactional fraud platform. As noted above, the query orchestration system may provide these account usage and fraud-related patterns and insights to the payment instrument authorization service, which may use these patterns and insights to define policies for automatically enriching transactions associated with different payment instruments as new transaction data is received. These enriched transactions may be used by the authorization processor to make authorization and settlement determinations, as well as detect any fraudulent activity associated with these transactions.

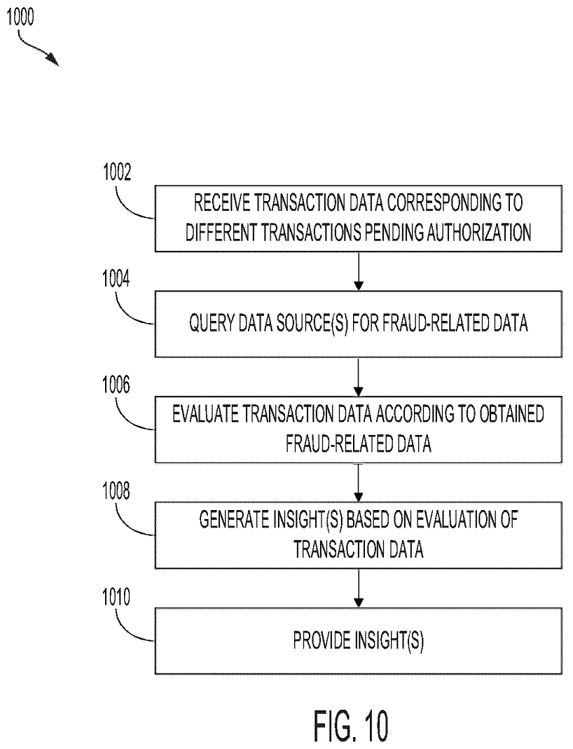

FIG. 10 shows an illustrative example of a process 1000 for evaluating transaction data according to fraud-related data to identify and provide fraud-related insights in accordance with at least one embodiment. The process 1000 may be performed by a data enhancement system implemented through a transactional fraud platform.

At step 1002, the data enhancement system may receive transaction data corresponding to different transactions pending authorization. As noted above, a payment instrument authorization service may query a set of transaction analysis systems (including the data enhancement system) implemented by the transactional fraud platform in parallel to identify different fraud-related patterns and insights that may be used to enrich pending transactions. These enriched pending transactions may be processed by the authorization processor, which may process the included fraud-related patterns and insights to determine whether to authorize and settle the corresponding transactions. To query the data enhancement system for different transaction classifications, the payment instrument authorization service may transmit the obtained transaction data to a query orchestration system implemented by the transactional fraud platform. The query orchestration system may automatically transmit the obtained transaction data to the data enhancement system to allow the data enhancement system to evaluate the transaction data.

At step 1004, the data enhancement system may query one or more data sources for fraud-related data that may be used to identify any fraud-related patterns and insights usable to enrich pending transactions prior to providing these transactions to the authorization processor for authorization and settlement. As noted above, the one or more data sources may include credit bureaus, credit reporting agencies, government agencies, and/or other fraud monitoring agencies that may monitor and report any fraud-related incidents to different entities and/or the general public. In some instances, the one or more data sources may further include merchants, retailers, or other entities that may be engaged in consumer transactions and that may detect fraudulent activity. The one or more data sources may further include data repositories and other systems maintained by the payment instrument authorization service and/or the transactional fraud platform. For example, the payment instrument authorization service and/or the transactional fraud platform may maintain data corresponding to fraud-related incidents detected by the payment instrument authorization service and/or the transactional fraud platform based on user communications, actions taken in response to detecting fraudulent activity, and the like.

At step 1006, the data enhancement system may evaluate the obtained transaction data according to the newly obtained fraud-related data from the one or more data sources. For example, if the obtained fraud-related data indicates that payment instruments associated with a particular private label (i.e., particular account types and/or account number characteristics) are linked to fraudulent activity, the data enhancement system may evaluate the obtained transaction data to identify any transactions associated with these payment instruments. As another illustrative example, if the obtained fraud-related data indicates that a particular entity (e.g., a merchant or retailer, a service provider, etc.) was the target of a data breach whereby user information has been compromised, the data enhancement system may scrutinize any transactions associated with payment instruments that may be related to the data breach.

At step 1008, the data enhancement system may generate different fraud-related patterns and insights based on evaluation of the obtained fraud-related data and the obtained transaction data. As noted above, the data enhancement system may implement a machine learning algorithm or artificial intelligence that is trained to identify any fraud-related patterns or insights from any data obtained from different data sources. This machine learning algorithm or artificial intelligence may be trained using a dataset of sample data and sample fraud-related patterns and insights corresponding to the sample data. The dataset may be analyzed by the machine learning algorithm or artificial intelligence by converting the sample data into a set of data embeddings and the sample fraud-related patterns and insights into a set of fraud-related embeddings. The machine learning algorithm or artificial intelligence may classify the sample external data according to one or more vectors of similarity between the set of data embeddings and the set of fraud-related embeddings. In some instances, the machine learning algorithm or artificial intelligence may be implemented with a threshold that may be used to determine, based on the aforementioned embeddings and the one or more vectors of similarity, whether sample data is sufficiently similar to a particular sample fraud-related pattern and/or insight. If a sample data does not satisfy the required threshold for classification to a particular known fraud-related pattern or insight, the machine learning algorithm or artificial intelligence may be trained to determine that no fraud-related pattern or insight can be derived from the sample data.

As noted above, through the machine learning algorithm or artificial intelligence, the data enhancement system may perform such clustering or classification of different fraud-related data as this fraud-related data is received from the different data sources. Through this processing of the different data, the data enhancement system may obtain partial matches among different known fraud-related patterns and/or insights to detect any fraud-related patterns and/or insights corresponding to the obtained data and that may be used to process obtained transaction data. Further, if evaluation of embeddings of a particular data fails to satisfy the aforementioned threshold for identification of a fraud-related pattern and/or insight that may be used to detect fraudulent transactions, the machine learning algorithm or artificial intelligence may automatically process transaction data according to other known fraud-related patterns and insights. As the data enhancement system generates fraud-related patterns and insights, the data enhancement system, at step 1010, may provide these fraud-related patterns and insights to the query orchestration system, which may provide these to the payment instrument authorization service.

As noted above, the transactional fraud platform may implement additional and/or alternative transaction analysis systems and corresponding processes to those described in FIGS. 7-10 to provide additional functionalities for fraud detection and for providing additional security layers for accounts associated with the payment instrument authorization service. For example, as noted above, the transactional fraud platform may implement a dynamic verification value evaluation microservice that is configured to automatically, and in real-time or near real-time, evaluate any transaction data submitted by different merchant systems as the transaction data is received to determine whether any included dynamic verification values are valid. These dynamic verification values may be generated according to a secret code shared between the payment instrument service and a payment instrument service application implemented on a user device. The secret code may be a statistically unique identifier that may serve as a verification value seed for the generation of dynamic verification values. Alternatively, in some instances, the secret code may be a shared secret established between the payment instrument service application and the payment instrument service, which implements the transactional fraud platform. The dynamic verification value evaluation microservice may evaluate transaction data corresponding to a transaction to determine whether a provided CVV (a dynamic verification value or static verification value) corresponds to the specified account. Based on this evaluation, the dynamic verification value evaluation microservice may enrich different transactions with fraud-related patterns and insights that may be used by the authorization processor to determine whether to authorize and settle these transactions.

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processing unit 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may easily be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed payment instrument service, the systems of the payment instrument service, and the systems and methods for dynamically, and in real-time, generating installment offers for mobile payment transactions performed through user devices can be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, generating installment offers for mobile payment transactions performed through user devices described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism. Examples of such connectors include, but are not limited to, an industry standard architecture (ISA “bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1114 can also include magnetic or optical data storage media including read-only (e.g., CD ROM and DVD ROM) or otherwise (e.g., CD or DVD). The memory can be local, remote, or distributed.

As described herein, the connector 1106 (or bus) can also couple the processor 1104 to the storage device 1110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. The interface can include one or more of a modem or other such network interfaces including, but not limited to those described herein. It will be appreciated that the network interface 1120 may be considered to be part of the computing device 1102 or may be separate from the computing device 1102. The network interface 1120 can include one or more of an analog modem, Integrated Services Digital Network (ISDN) modem, cable modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1122 can be wired connections, wireless connections, or combinations thereof. Communications via the network 1122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1102 and presented to a user of the computing device 1102 using forms that are perceptible via sight, sound, smell, taste, touch, or other such mechanisms. In some embodiments, communications over the network 1122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1102 and/or the computing device 1124 can be connected to a computing resources provider 1128 via the network 1122 using a network interface such as those described herein (e.g., network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

In an embodiment, the computing device 1102 can be connected to one or more additional computing devices and/or services such as merchant computing device 1136 and/or a point-of-sale service 1134 via the network 1122 and using a connection such as the network interface 1120. In an embodiment, the point-of-sale service 1134 is separate from the merchant computing device 1136. In an embodiment, the point-of-sale service 1134 is executing on the merchant computing device 1136. In an embodiment, the point-of-sale service 1134 is executing as one or more services (e.g., the service 1130 and/or the service 1132) operating within the environment of the computing resources provider. As used herein, a point-of-sale service 1134 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 1136 to interact with the point-of-sale service 1134. In an embodiment, the merchant computing device 1136 is a dedicated point-of-service (POS) terminal. In an embodiment, the merchant computing device 1136 is a cash register system. In an embodiment, the merchant computing device 1136 is an application or web service operating on a computing device such as the computing device 1102 described herein. In such an embodiment, the application or web service may be provided by a financial services system (e.g., a bank, a transaction processing system, an inventory management system, or some other such financial services system). In an embodiment, the merchant computing device 1136 includes an auxiliary device or system to execute tasks associated with the point-of-sale service 1134 (e.g., a payment instrument processing device attached to a smart phone or tablet). In an embodiment, the merchant computing device 1136 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 1136 is a virtual device (e.g., a virtual kiosk) such as the virtual devices described herein. Although not illustrated here, in an embodiment, the merchant computing device 1136 may be one of a plurality of devices that may be interconnected using a network such as the network 1122.

In an embodiment, the computing device 1102 can be connected to one or more additional computing devices and/or services such as a payment instrument service 1138 via the network 1122 and using a connection such as the network interface 1120. In an embodiment, the payment instrument service 1138 connects directly with the point of sale service 1134. In an embodiment, elements of the payment instrument service 1138 are executing on the merchant computing device 1136. In an embodiment, the payment instrument service 1138 is executing as one or more services (e.g., the service 1130 and/or the service 1132) operating within the environment of the computing resources provider. As used herein, a payment instrument service 1138 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 1138 are running as an application or web service operating on a computing device such as the computing device 1102 described herein. In such an embodiment, the application or web service of the payment instrument service 1138 may be provided by a financial services system (e.g., a bank, a transaction processing system, an inventory management system, or some other such financial services system). In an embodiment, elements of the payment instrument service 1138 are running on an auxiliary device or system configured to execute tasks associated with the payment instrument service 1138 (e.g., uses a payment instrument processing device attached to a smart phone or tablet). In an embodiment, elements of the payment instrument service 1138 are running on virtual device such as those described herein. Although not illustrated here, in an embodiment, the payment instrument service 1138 may be running on one or more of a plurality of devices that may be interconnected using a network such as the network 1122.

In an embodiment, the computing device 1102 can be connected to one or more additional computing devices and/or services such as an authentication service 1140 via the network 1122 and using a connection such as the network interface 1120. In an embodiment, the authentication service 1140 is an element of the payment instrument service 1138. In an embodiment, the authentication service 1140 is separate from the payment instrument service 1138. In an embodiment, the authentication service 1140 connects directly with the point of sale service 1134. In an embodiment, elements of the authentication service 1140 are executing on the merchant computing device 1136. In an embodiment, the authentication service 1140 is executing as one or more services (e.g., the service 1130 and/or the service 1132) operating within the environment of the computing resources provider. As used herein, an authentication service 1140 is a service used by one or more merchants to authenticate transactions associated with payment instruments. An authentication service may be a third-party service that provides secure and verified authorization of the transactions.

In an embodiment, elements of the authentication service 1140 are running as an application or web service operating on a computing device such as the computing device 1102 described herein. In such an embodiment, the application or web service of the authentication service 1140 may be provided by a financial services system (e.g., a bank, a transaction processing system, an inventory management system, or some other such financial services system). In an embodiment, elements of the authentication service 1140 are running on an auxiliary device or system configured to execute tasks associated with the authentication service 1140 (e.g., provides authentication using payment instrument processing device attached to a smart phone or tablet). In an embodiment, elements of the authentication service 1140 are running on virtual device such as those described herein. Although not illustrated here, in an embodiment, the authentication service 1140 may be running on one or more of a plurality of devices that may be interconnected using a network such as the network 1122.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1102) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory, or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, meta-learning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1102.

In general, the routines executed to implement the implementations of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

1. A computer-implemented method, comprising:
receiving transaction data associated with different transactions pending authorization, wherein the transaction data corresponds to different external systems;
replicating, by a query orchestration system, the transaction data for transmission of individual copies of the transaction data to different transaction analysis machine learning algorithms;
processing the individual copies of the transaction data through the different transaction analysis machine learning algorithms simultaneously and in parallel to generate fraud-related patterns usable to detect fraudulent transactions, wherein the different transaction analysis machine learning algorithms are trained using datasets including sample transaction data and expected fraud-related patterns corresponding to the sample transaction data, and wherein the different transaction analysis machine learning algorithms generate the fraud-related patterns within an authorization decision time restraint;
consolidating, by the query orchestration system, the fraud-related patterns generated by the different transaction analysis machine learning algorithms, wherein the fraud-related patterns are consolidated within the authorization decision time restraint;
enriching the transaction data with the fraud-related patterns within the authorization decision time restraint and prior to transmission to an authorization processor, wherein the transaction data is enriched by updating one or more data fields of the transaction data to include values corresponding to the fraud-related patterns;
transmitting the enriched transaction data, wherein when the modified transaction data is received at an authorization processor, the authorization processor generates authorization decisions corresponding to the different transactions within the authorization decision time restraint and according to the values corresponding to the fraud-related patterns;
obtaining the authorization decisions and additional fraud-related patterns corresponding to the different transactions, wherein the additional fraud-related patterns are generated according to the authorization decisions;
dynamically updating the datasets according to the authorization decisions and the additional fraud-related patterns, wherein the updated datasets are used to dynamically retrain the different transaction analysis machine learning algorithms to improve fraud-related pattern identification and detection of fraudulent transactions within the authorization decision time restraint; and
processing new transaction data through the retrained different transaction analysis machine learning algorithms simultaneously and in parallel to generate new fraud-related patterns within the authorization decision time restraint.

2. The computer-implemented method of claim 1, wherein:
the transaction data includes one or more dynamic verification values corresponding to payment instruments used for one or more transactions; and
the computer-implemented method further comprises comparing the one or more dynamic verification values to a set of reference dynamic verification values to generate a subset of the fraud-related patterns within the authorization decision time restraint.

3. The computer-implemented method of claim 1, wherein processing the individual copies of the transaction data through the different transaction analysis machine learning algorithms further comprises further comprises:
processing a set of pre-authorization records and an individual copy of the transaction data through a pre-authorization query machine learning algorithm to obtain a subset of the fraud-related patterns within the authorization decision time restraint.

4. The computer-implemented method of claim 1, wherein processing the individual copies of the transaction data through the different transaction analysis machine learning algorithms further comprises further comprises:
processing an individual copy of the transaction data and a set of address verification and identification number rules through a rules query machine learning algorithm to generate a subset of the fraud-related patterns within the authorization decision time restraint, wherein the rules query machine learning algorithm is trained using a dataset including the sample transaction data, sample rule patterns, and the expected fraud-related patterns.

5. The computer-implemented method of claim 1, wherein:
the transaction data includes plaintext account identifiers corresponding to different accounts; and
processing the individual copies of the transaction data through the different transaction analysis machine learning algorithms further comprises processing the plaintext account identifiers through a transactional customer query machine learning algorithm to generate a subset of the fraud-related patterns within the authorization decision time restraint.

6. The computer-implemented method of claim 1, wherein processing the individual copies of the transaction data through the different transaction analysis machine learning algorithms further comprises further comprises:
querying one or more data sources for fraud-related data; and
processing an individual copy of the transaction data and the fraud-related data through a data enhancement machine learning algorithm to generate a subset of the fraud-related patterns within the authorization decision time restraint.

7. (canceled)

8. A system, comprising:
one or more processors; and
memory storing thereon instructions that, as a result of being executed by the one or more processors, cause the system to:
receive transaction data associated with different transactions pending authorization, wherein the transaction data corresponds to different external systems;
replicate the transaction data for transmission of individual copies of the transaction data to different transaction analysis machine learning algorithms;
process the individual copies of the transaction data through the different transaction analysis machine learning algorithms simultaneously and in parallel to generate fraud-related patterns usable to detect fraudulent transactions, wherein the different transaction analysis machine learning algorithms are trained using datasets including sample transaction data and expected fraud-related patterns corresponding to the sample transaction data, and wherein the different transaction analysis machine learning algorithms generate the fraud-related patterns within an authorization decision time restraint;
consolidate the fraud-related patterns generated by the different transaction analysis machine learning algorithms, wherein the fraud-related patterns are consolidated within the authorization decision time restraint;
enrich the transaction data with the fraud-related patterns within the authorization decision time restraint and prior to transmission to an authorization processor, wherein the transaction data is enriched by updating one or more data fields of the transaction data to include values corresponding to the fraud-related patterns;
transmit the enriched transaction data, wherein when the modified transaction data is received at an authorization processor, the authorization processor generates authorization decisions corresponding to the different transactions within the authorization decision time restraint and according to the values corresponding to the fraud-related patterns;
obtain the authorization decisions and additional fraud-related patterns corresponding to the different transactions, wherein the additional fraud-related patterns are generated according to the authorization decisions;
dynamically update the datasets according to the authorization decisions and the additional fraud-related patterns, wherein the updated datasets are used to dynamically retrain the different transaction analysis machine learning algorithms to improve fraud-related pattern identification and detection of fraudulent transactions within the authorization decision time restraint; and
process new transaction data through the retrained different transaction analysis machine learning algorithms simultaneously and in parallel to generate new fraud-related patterns within the authorization decision time restraint.

9. The system of claim 8, wherein:
the transaction data includes one or more dynamic verification values corresponding to payment instruments used for one or more transactions; and
the instructions further cause the system to compare the one or more dynamic verification values to a set of reference dynamic verification values to generate a subset of the fraud-related patterns within the authorization decision time restraint.

10. The system of claim 8, wherein the instructions that cause the system to process the individual copies of the transaction data through the different transaction analysis machine learning algorithms further cause the system to:
process a set of pre-authorization records and an individual copy of the transaction data through a pre-authorization query machine learning algorithm to obtain a subset of the fraud-related patterns within the authorization decision time restraint.

11. The system of claim 8, wherein the instructions that cause the system to process the individual copies of the transaction data through the different transaction analysis machine learning algorithms further cause the system to:
process an individual copy of the transaction data and a set of address verification and identification number rules through a rules query machine learning algorithm to generate a subset of the fraud-related patterns within the authorization decision time restraint, wherein the rules query machine learning algorithm is trained using a dataset including the sample transaction data, sample rule patterns, and the expected fraud-related patterns.

12. The system of claim 8, wherein:
the transaction data includes plaintext account identifiers corresponding to different accounts; and
the instructions that cause the system to process the individual copies of the transaction data through the different transaction analysis machine learning algorithms further cause the system to process the plaintext account identifiers through a transactional customer query machine learning algorithm to generate a subset of the fraud-related patterns within the authorization decision time restraint.

13. The system of claim 8, wherein the instructions that cause the system to process the individual copies of the transaction data through the different transaction analysis machine learning algorithms further cause the system to:
query one or more data sources for fraud-related data; and
process an individual copy of the transaction data and the fraud-related data through a data enhancement machine learning algorithm to generate a subset of the fraud-related patterns within the authorization decision time restraint.

14. (canceled)

15. A non-transitory computer-readable storage medium storing thereon executable instructions that, as a result of being executed by one or more processors of a computer system, cause the computer system to:
receive transaction data associated with different transactions pending authorization, wherein the transaction data corresponds to different external systems;
replicate the transaction data for transmission of individual copies of the transaction data to different transaction analysis machine learning algorithms;
process the individual copies of the transaction data through the different transaction analysis machine learning algorithms simultaneously and in parallel to generate fraud-related patterns usable to detect fraudulent transactions, wherein the different transaction analysis machine learning algorithms are trained using datasets including sample transaction data and expected fraud-related patterns corresponding to the sample transaction data, and wherein the different transaction analysis machine learning algorithms generate the fraud-related patterns within an authorization decision time restraint;
consolidate the fraud-related patterns generated by the different transaction analysis machine learning algorithms, wherein the fraud-related patterns are consolidated within the authorization decision time restraint;
enrich the transaction data with the fraud-related patterns within the authorization decision time restraint and prior to transmission to an authorization processor, wherein the transaction data is enriched by updating one or more data fields of the transaction data to include values corresponding to the fraud-related patterns;
transmit the enriched transaction data, wherein when the modified transaction data is received at an authorization processor, the authorization processor generates authorization decisions corresponding to the different transactions within the authorization decision time restraint and according to the values corresponding to the fraud-related patterns;
obtain the authorization decisions and additional fraud-related patterns corresponding to the different transactions, wherein the additional fraud-related patterns are generated according to the authorization decisions;
dynamically update the datasets according to the authorization decisions and the additional fraud-related patterns, wherein the updated datasets are used to dynamically retrain the different transaction analysis machine learning algorithms to improve fraud-related pattern identification and detection of fraudulent transactions within the authorization decision time restraint; and
process new transaction data through the retrained different transaction analysis machine learning algorithms simultaneously and in parallel to generate new fraud-related patterns within the authorization decision time restraint.

16. The non-transitory computer-readable storage medium of claim 15, wherein:
the transaction data includes one or more dynamic verification values corresponding to payment instruments used for one or more transactions; and
the executable instructions further cause the computer system to compare the one or more dynamic verification values to a set of reference dynamic verification values to generate a subset of the fraud-related patterns within the authorization decision time restraint.

17. The non-transitory computer-readable storage medium of claim 15, wherein the executable instructions that cause the computer system to process the individual copies of the transaction data through the different transaction analysis machine learning algorithms further cause the computer system to:
process a set of pre-authorization records and an individual copy of the transaction data through a pre-authorization query machine learning algorithm to obtain a subset of the fraud-related patterns within the authorization decision time restraint.

18. The non-transitory computer-readable storage medium of claim 15, wherein the executable instructions that cause the computer system to process the individual copies of the transaction data through the different transaction analysis machine learning algorithms further cause the computer system to:
process an individual copy of the transaction data and a set of address verification and identification number rules through a rules query machine learning algorithm to generate a subset of the fraud-related patterns within the authorization decision time restraint, wherein the rules query machine learning algorithm is trained using a dataset including the sample transaction data, sample rule patterns, and the expected fraud-related patterns.

19. The non-transitory computer-readable storage medium of claim 15, wherein:
the transaction data includes plaintext account identifiers corresponding to different accounts; and
the executable instructions that cause the computer system to process the individual copies of the transaction data through the different transaction analysis machine learning algorithms further cause the computer system to process the plaintext account identifiers through a transactional customer query machine learning algorithm to generate a subset of the fraud-related patterns within the authorization decision time restraint.

20. The non-transitory computer-readable storage medium of claim 15, wherein the executable instructions that cause the computer system to process the individual copies of the transaction data through the different transaction analysis machine learning algorithms further cause the computer system to:
query one or more data sources for fraud-related data; and
process an individual copy of the transaction data and the fraud-related data through a data enhancement machine learning algorithm to generate a subset of the fraud-related patterns within the authorization decision time restraint.

21. (canceled)

22. The computer-implemented method of claim 1, wherein the different transaction analysis machine learning algorithms are implemented through a set of scalable resources, and wherein the set of scalable resources is expandable according to data spikes corresponding to incoming transaction data.

23. The system of claim 8, wherein the different transaction analysis machine learning algorithms are implemented through a set of scalable resources, and wherein the set of scalable resources is expandable according to data spikes corresponding to incoming transaction data.

24. The non-transitory computer-readable storage medium of claim 15, wherein the different transaction analysis machine learning algorithms are implemented through a set of scalable resources, and wherein the set of scalable resources is expandable according to data spikes corresponding to incoming transaction data.
